(19) United States
(12) Patent Application Publication
(10) Pub. No.: US 2025/0269376 A1
(43) Pub. Date: Aug. 28, 2025

(54) SYSTEMS AND METHODS FOR THERMAL, EVAPORATION AND VOLUME CONTROL IN A FLOW CELL

(71) Applicant: 10x Genomics, Inc., Pleasanton, CA (US)

(72) Inventors: Yiran Zhang, Castro Valley, CA (US); Tobias Daniel Wheeler, Pleasanton, CA (US); Xueda Shi, San Jose, CA (US); Brenden Janatpour Brown, Castro Valley, CA (US); Marissa Pennell, San Ramon, CA (US)

(21) Appl. No.: 19/060,122

(22) Filed: Feb. 21, 2025

Related U.S. Application Data
(60) Provisional application No. 63/556,556, filed on Feb. 22, 2024.

(51) Int. Cl. B01L 3/00

(52) U.S. Cl. CPC B01L 3/50853; B01L 2200/027; B01L 2200/0689

(57) ABSTRACT

An adapter for incorporation into an open well flow cell, the adapter including a body having an upper surface, a lower surface spaced from the upper surface defining a thickness profile therebetween, at least one side extending about a perimeter of the body, an inlet formed in the body extending through the thickness of the upper surface and the lower surface, at least one foot extending from the lower surface, each foot of the at least one foot extending a vertical distance away from the lower surface and a protrusion extending from the upper surface. The adaptor configured to be placed over, or onto, an open well flow cell to form an effectively closed, and reversible, flow cell. A variety of structural features are included to inhibit/prohibit gas bubbles from evaporating from the fluid reagent within the cell, and/or providing egress or venting of such bubbles.

### CROSS-REFERENCE TO RELATED APPLICATIONS

This application claims the benefit of priority U.S. Provisional App. No. 63/556,556, filed on Feb. 22, 2024. The entire contents of which are hereby incorporated by reference.

### FIELD

The present disclosure relates to an adapter configured for reversibly converting an open well flow cell into a closed flow cell, and for a reversible flow cell assembly. Additionally, the present disclosure is directed to methods for assembling a reversible closed flow cell using an open well flow cell and a removable adapter for thermal, evaporation and volume control.

### BACKGROUND

Many biomedical applications rely on high-throughput assays of biological samples combined with one or more reagents using flow devices (e.g., open well flow cells and closed flow cells). For example, in both research and clinical applications, high-throughput assays using target-specific reagents for analyzing molecules present in a biological sample can provide information for various applications. Reducing the volume of reagent(s) employed can significantly reduce cost, and cycle time (i.e., less volume of liquid is required to be delivered to, and removed, the tissue sample).

Open well flow cells are generally preferable to closed flow cells when performing imaging of a biological sample (e.g., cell or tissue sample) disposed therein because imaging optics can be immersed in an immersion fluid contained within the open well and also because there is no material between the imaging optics and sample causing unwanted optical distortions (that would have to be corrected). However, conventional open well flow cells require excessive reagent to fill the open well (and fully submerge a sample) which may lead to increased cost, incubation time and unrepeatable preparation of samples. Conventional open well flow cells may also be susceptible to evaporation due to thermal cycling which further reduces the reagent within a well which may lead to increased cost in replacing or replenishing said reagent and/or insufficient incubation periods for biological samples within the well. When expensive reagents (e.g., fluorescently labelled monoclonal antibodies) are used during preparation of a biological sample for analysis, minimizing the amount of reagent used throughout sample preparation is important to reduce the cost-per-sample.

Accordingly, there exists a need for an adaptor, and flow cell assembly, which provides thermal, evaporation and volume control of reagents within the flow cell.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes an adapter for an open well flow cell, the adapter including a body having an upper surface, a lower surface spaced from the upper surface defining a thickness profile therebetween, at least one side extending about a perimeter of the body, an inlet formed in the body extending through the thickness of the upper surface and the lower surface, at least one foot extending from the lower surface, each foot of the at least one foot extending a vertical distance away from the lower surface and a protrusion extending from the upper surface.

To achieve these and other advantages and in accordance with the purpose of the disclosed subject matter, as embodied and broadly described, the disclosed subject matter includes an adapter for an open well flow cell, the adapter including a substrate having an upper surface, a lower surface spaced from the upper surface to define a thickness profile therebetween, a first end and a second end spaced along a longitudinal axis, at least one side defining a perimeter of the substrate, a support structure extending around the perimeter of the substrate from the upper surface to the lower surface, an inlet formed in the support structure and extending through the thickness of the upper surface and the lower surface, a first gas permeable layer disposed on the upper surface of the substrate, a second gas permeable layer disposed on the lower surface of the substrate, at least one foot extending from the second gas permeable layer.

To achieve these and other advantages and in accordance with the purpose of the disclosed subject matter, as embodied and broadly described, the disclosed subject matter includes an open well flow cell assembly, the assembly including a cassette formed by an upper casing and a lower casing, wherein the upper casing is releasably coupled from to the lower casing, wherein a gap is formed between the upper casing and the lower casing when the upper casing is coupled to the lower casing, a sample substrate disposed in the gap, an opening formed in the upper casing, the opening circumscribed by a gasket, wherein the gasket and the sample substrate form an open well, an adapter disposed in the well, the adapter having a body having an upper surface, a lower surface spaced from the upper surface defining a thickness profile therebetween, at least one side extending about a perimeter of the body, an inlet formed in the body extending through the thickness of the upper surface and the lower surface, the notch inlet configured to receive a fluid into the well, at least one foot extending from the lower surface of at least one side of the body, each foot of the at least one foot extending a vertical distance away from the lower surface and a protrusion extending from the upper surface.

To achieve these and other advantages and in accordance with the purpose of the disclosed subject matter, as embodied and broadly described, the disclosed subject matter includes an open well flow cell assembly, the assembly including a cassette formed by an upper casing and a lower casing, wherein the upper casing is releasably coupled to the lower casing, wherein a gap is formed between the upper casing and the lower casing when the upper casing is coupled to the lower casing, a sample substrate disposed in the gap, an opening formed in the upper casing of the cassette, the opening circumscribed by a gasket, wherein the gasket and the sample substrate form an open well, a cassette lid disposed over the well, the cassette lid configured to couple to the cassette and form a seal with the gasket, the cassette lid further having a body having an upper surface, a lower surface, spaced from the upper surface defining a thickness profile therebetween, and an inlet formed in the body extending from the upper surface to the lower surface.

To achieve these and other advantages and in accordance with the purpose of the disclosed subject matter, as embodied and broadly described, the disclosed subject matter includes a method including providing an open well flow cell having a sample disposed on a substrate, the open well flow cell comprising a cassette formed by an upper casing and a lower casing, wherein the upper casing is releasably coupled from the lower casing, wherein a gap is formed between the upper casing and the lower casing when the upper casing is coupled to the lower casing, a sample substrate disposed in the gap, an opening formed in the upper casing, the opening circumscribed by a gasket, wherein the gasket and the sample substrate form an open well, positioning the adapter as described herein in the open well to thereby form a reversible flow cell, flowing at least one reagent into the inlet thereby contacting the sample with the at least one reagent.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present disclosure and may illustrate one or more embodiment(s) or example(s) of the present disclosure in whole or in part.

FIGS. 1A-1L are schematic representations of an adapter for a flow cell in accordance with the present disclosure.

FIG. 2 shows various planform views of the adapter for a flow cell in accordance with the present disclosure.

FIGS. 3A-3F are schematic representations of a gas permeable adapter for a flow cell in accordance with the present disclosure.

FIGS. 4A-4F are schematic representations of a cassette for a flow cell utilizing the adapter in accordance with the present disclosure.

FIGS. 4G-4N illustrate a sample device according to embodiments of the present disclosure.

FIGS. 5A-5B are schematic cross-sectional views of the flow cell utilizing the adapter in accordance with the present disclosure.

FIGS. 6A-6B are schematic representations of the flow cell being filled and sealed in accordance with the present disclosure.

FIG. 7 is an exemplary flow chart of the method of forming a reversible flow cell in accordance with the present disclosure.

### DETAILED DESCRIPTION

### Definitions

To facilitate the understanding of this disclosure, a number of terms are defined below. Terms defined herein have meanings as commonly understood by a person of ordinary skill in the areas relevant to the disclosure. Terms such as “a”, “an,” and “the” are not intended to refer to only a singular entity, but include the general class of which a specific example may be used for illustration. The terminology herein is used to describe specific embodiments of the disclosure, but their usage does not limit the disclosure, except as outlined in the claims.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

As used herein, any values provided in a range of values include both the upper and lower bounds, and any values contained within the upper and lower bounds.

The term “biological particle,” as used herein, generally refers to a discrete biological system derived from a biological sample. The biological particle may be a virus. The biological particle may be a cell or derivative of a cell. The biological particle may be an organelle from a cell. Examples of an organelle from a cell include, without limitation, a nucleus, endoplasmic reticulum, a mitochondrion, a ribosome, a Golgi apparatus, an endoplasmic reticulum, a chloroplast, an endocytic vesicle, an exocytic vesicle, a vacuole, and a lysosome. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) including a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell but may not include other constituents of the cell. An example of such constituents is a nucleus or an organelle. A cell may be a live cell. The live cell may be capable of being cultured, for example, being cultured when enclosed in a gel or polymer matrix or cultured when including a gel or polymer matrix.

The term “fluidically connected”, as used herein, refers to a direct connection between at least two device elements, e.g., a channel, reservoir, etc., that allows for fluid to move between such device elements without passing through an intervening element.

The term “genome,” as used herein, generally refers to genomic information from a subject, which may be, for example, at least a portion or an entirety of a subject's hereditary information. A genome can be encoded either in DNA or in RNA. A genome can include coding regions that code for proteins as well as non-coding regions. A genome can include the sequence of all chromosomes together in an organism.

For example, the human genome has a total of 46 chromosomes. The sequence of all of these together may constitute a human genome.

The term “in fluid communication with”, as used herein, refers to a connection between at least two device elements, e.g., a channel, reservoir, etc., that allows for fluid to move between such device elements with or without passing through one or more intervening device elements.

The term “macromolecular constituent,” as used herein, generally refers to a macromolecule contained within or from a biological particle. The macromolecular constituent may include a nucleic acid. In some cases, the biological particle may be a macromolecule. The macromolecular constituent may include DNA or a DNA molecule. The macromolecular constituent may include RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may include a protein. The macromolecular constituent may include a peptide. The macromolecular constituent may include a polypeptide or a protein. The polypeptide or protein may be an extracellular or an intracellular polypeptide or protein. The macromolecular constituent may also include a metabolite. These and other suitable macromolecular constituents (also referred to as analytes) will be appreciated by those skilled in the art (see U.S. Pat. Nos. 10,011,872 and 10,323,278, and PCT Publication No. WO 2019/157529, each of which is incorporated herein by reference in its entirety).

The term “particulate component of a cell” refers to a discrete biological system derived from a cell or fragment thereof and having at least one dimension of 0.01 μm (e.g., at least 0.01 μm, at least 0.1 μm, at least 1 μm, at least 10 μm, or at least 100 μm). A particulate component of a cell may be, for example, an organelle, such as a nucleus, an exosome, a liposome, an endoplasmic reticulum (e.g., rough or smooth), a ribosome, a Golgi apparatus, a chloroplast, an endocytic vesicle, an exocytic vesicle, a vacuole, a lysosome, or a mitochondrion.

The terms “sample,” “tissue sample,” and “biological tissue sample” as used herein, refers to material from a subject, such as a biopsy, core biopsy, tissue section, needle aspirate, or fine needle aspirate or skin sample. The biological tissue sample may be derived from another sample. The biological sample may be a nucleic acid sample or protein sample. The sample may be a liquid sample, such as a blood sample, urine sample, or saliva sample. The sample may be a skin sample. The sample may be a cheek swap. The sample may be a plasma or serum sample. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool, and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively, or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

The term “inlet” and “port” as used herein, generally refers to an aperture, orifice or channel extending through at least a portion of a device layer.

Reference will now be made in detail to exemplary embodiments of the disclosed subject matter, an example of which is illustrated in the accompanying drawings. The method and corresponding steps of the disclosed subject matter will be described in conjunction with the detailed description of the system.

The methods, assemblies, and systems presented herein relate to an adapter configured to reduce a volume of reagent required to fully contact (e.g., submerge) a biological sample (e.g. cell or tissue sample) in an open well flow cell, thereby forming a reversible flow cell upon positioning of the adapter in the well. Reducing the volume of the open well reduces the amount of reagent(s) needed for sample preparation (e.g., tissue sample preparation for analysis of biological molecules, such as RNAs and/or proteins), which provides significant cost savings when using expensive sample preparation reagents (e.g., one or more antibodies) and can also reduce cycle time, as less time is need to dispense and remove the reagent(s) employed. An “open well flow cell” may also be referred to simply as an “open well” and generally refers to any well or recess that is configured to receive a sample (e.g., a biological tissue or hydrogel) and receive and hold at least a predetermined volume of liquid (e.g., one or more reagents, such as fluorescently tagged oligonucleotides, fluorescently tagged nucleotides, or an imaging buffer for improved microscopy resolution and/or keeping the sample hydrated during imaging) therein. For purpose of illustration and without limitation, in an exemplary embodiment, the height of liquid required in the flow cell can be reduced from approximately 1.0 mm (1000 μm) to approximately 0.2 mm (200 μm). This approximately 0.8 mm spatial reduction can reduce the amount of reagent volume used within the flow cell from 500 μl to approximately 100 μl.

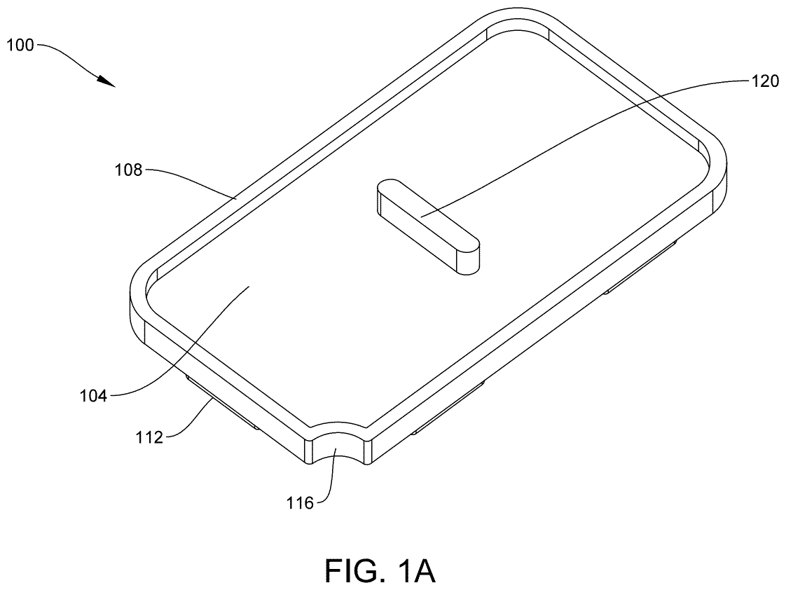

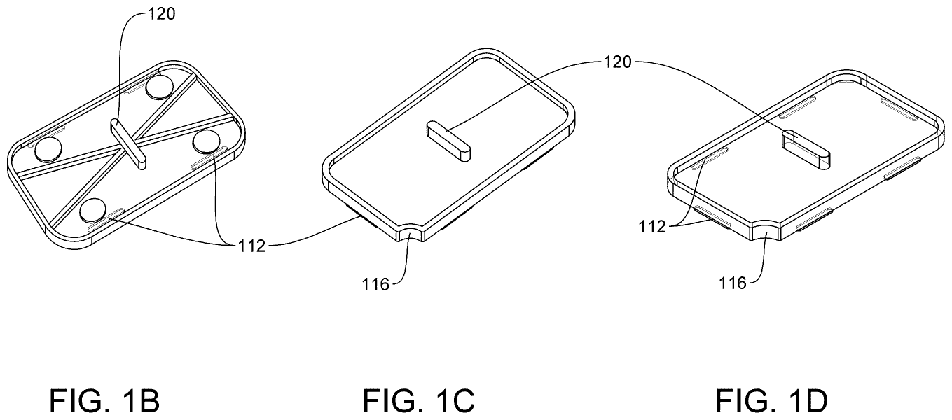

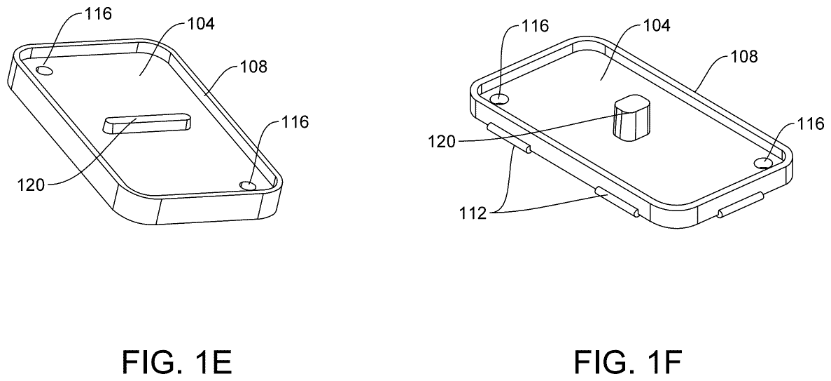

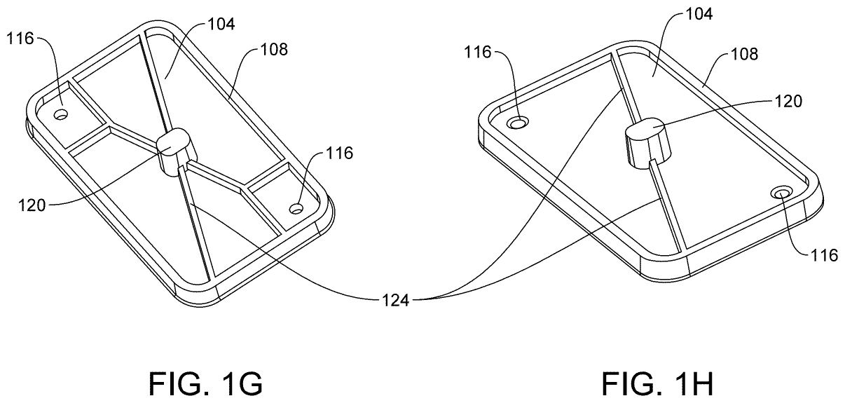

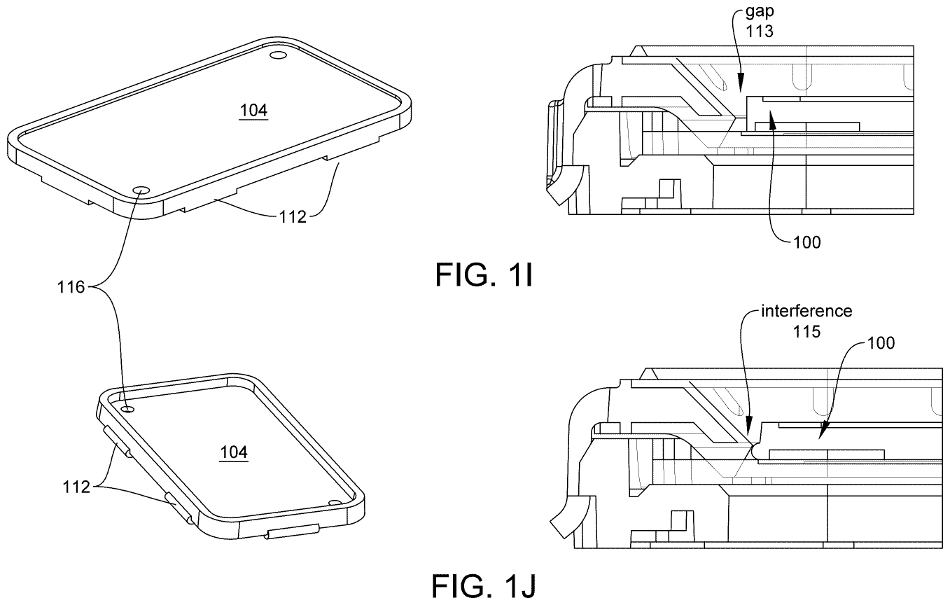

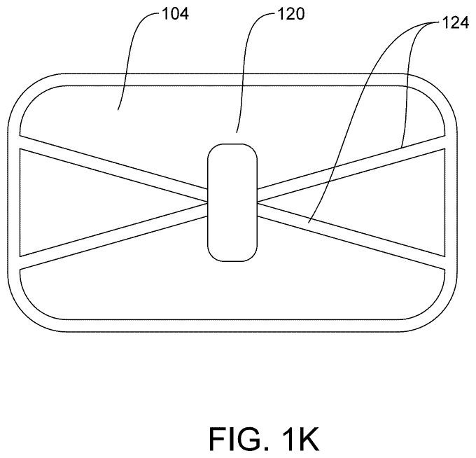

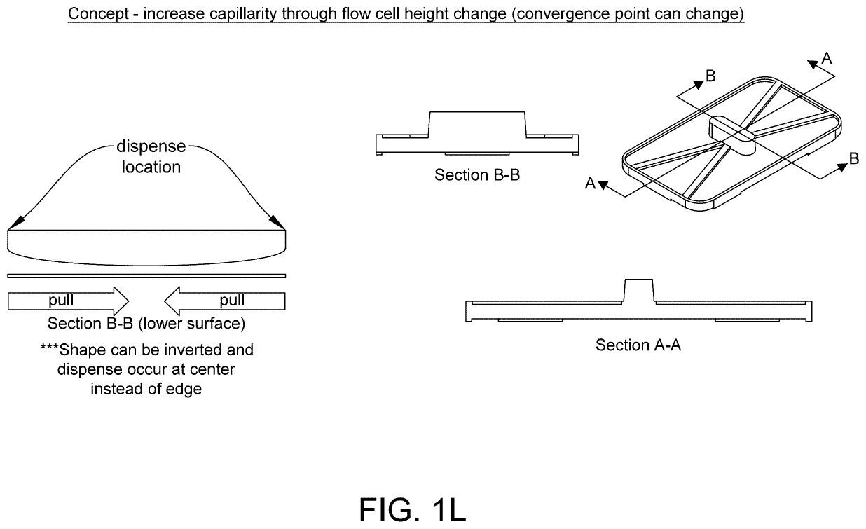

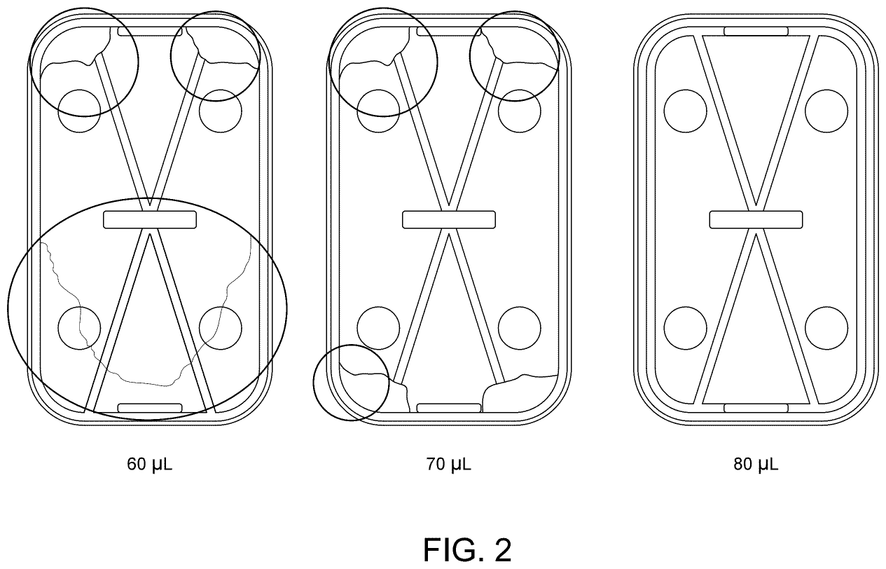

FIG. 1A shows a perspective view of an adapter 100 for a flow cell. In various embodiments, the flow cell is an open well flow cell (e.g., a well having side walls and a base with no cover or top portion to allow for the dispensing and extraction of one or more reagents therein). Once the adapter 100 is inserted into the open well and seated against the base of the well (e.g., a glass sample slide), the open well flow cell and the adapter 100 collectively form a reversible, closed flow cell having a predetermined volume (that is a reduced volume compared to the total volume of the open well flow cell). In various embodiments, the open well flow cell and the adapter 100 collectively form an inlet for providing fluid (e.g., one or more reagents). In various embodiments, the open well flow cell and the adapter 100 collectively form an outlet for extracting fluid (e.g., one or more reagents) from the reversibly formed closed flow cell. After the adapter 100 is seated against the base of the open well (e.g., one or more hard stops or feet of the adapter 100 contact the sample substrate forming the base of the open well), any fluid reagent provided in the inlet is bounded within, and capable of flowing through, a chamber formed by the underside of the adaptor 100, the base of the open well (e.g., a glass sample slide or substrate) on which the sample is disposed, and the sidewall(s) of the open well (e.g., walls formed by a cassette and/or gasket). In various embodiments, the sidewalls of the open well may be vertical (i.e., forming a 90-degree angle with the base). In various embodiments, the sidewall(s) may be angled with respect to the horizontal plane of the base. In various embodiments, the angle of the sidewall(s) substantially matches an angle of a distal portion of an objective lens, to thereby allow for increased travel of the objective within the well and an increased imageable area. In various embodiments, the sidewall(s) include a substantially vertical portion and an angled portion above the substantially vertical portion. In various embodiments, the vertical portion of the sidewall(s) has a height of about 1 μm to about 100 μm. In various embodiments, the vertical portion of the sidewall(s) has a height of about 1 μm to about 20 μm. In various embodiments, the vertical portion of the sidewall(s) has a height of about 1 μm to about 10 μm. In various embodiments, the vertical portion of the sidewall(s) has a height of about 5 μm to about 10 μm.

As shown in FIG. 1A, the adapter 100 includes a body portion 104. The body portion 104 is formed with generally planar upper and lower surfaces, defining a thickness profile therebetween. In various embodiments, the upper surface is non-planar. In various embodiments, the lower surface is non-planar. In various embodiments, the upper surface is non-planar while the lower surface is planar, or vice versa (i.e., the upper surface is planar while the lower surface is non-planar). In various embodiments, the upper and lower surfaces are generally rectilinear or rectangular in planform shape. In various embodiments, the body portion 104 includes squared or right-angle corners, for example, four right angle corners. In various embodiments, as shown in FIG. 1A, the body portion 104 includes chamfered or rounded (also referred to as radiused) corners. The corners of body portion 104 may include any suitable radius, including radii which correspond to an interior sidewall of a well of an open well flow cell. In various embodiments, the body portion 104 may be oblong or circular in planform shape.

In various embodiments, the body portion 104 is generally rectangular, as shown in FIG. 1A. In various embodiments, the dimensions of the body portion 104 substantially correspond to (e.g., are substantially equal to, are less than about 5% smaller than) dimensions of the interior walls of a well of an open flow cell. In various embodiments, the rectangular shape includes short sides (e.g., first and second short sides) are about 5 mm to about 50 mm in length. In various embodiments, the short sides are about 10 mm to about 20 mm in length. In various embodiments, the short sides are approximately 16 mm in length. In various embodiments, the rectangular shape includes long sides (e.g., first and second long sides) extending from the first and second short side. In various embodiments, the long sides are about 10 mm to about 100 mm in length. In various embodiments, the long sides are about 10 mm to about 50 mm in length. In various embodiments, the long sides are about 20 mm to about 30 mm in length. In various embodiments, the long sides are approximate 28 mm in length. In various embodiments, the adapter 100 includes a width of about 15.5 mm and a length of about 27.5 mm, for example. In various embodiments, the adaptor 100 is formed with non-linear sides, e.g., curved, undulating, and/or with an overall round or circular profile. In various embodiments, the adaptor 100 includes one or more projections extending radially away from the main body and configured to secure the adapter 100 within the open well (e.g., reduce or prevent motion, such as translation and rotation, of the adapter 100 relative to the open well).

In various embodiments, adapter 100 has a thickness profile defined between the upper and lower surfaces. In some embodiments, the thickness profile is about 100 μm to about 5 cm. In some embodiments, the thickness profile is about 100 μm to about 5 mm. In some embodiments, the thickness profile is about 1 mm to about 5 mm. In some embodiments, the thickness profile is about 1 mm to about 10 mm. In some embodiments, the thickness profile is about 1 mm to about 20 mm. In some embodiments, the thickness profile is about 1 mm to about 30 mm. In some embodiments, the thickness profile is about 1 mm to about 40 mm. In some embodiments, the thickness profile is about 1 mm to about 50 mm. In some embodiments, the thickness profile is about 1 mm to about 60 mm. In some embodiments, the thickness profile is about 1 mm to about 70 mm. In some embodiments, the thickness profile is about 1 mm to about 80 mm. In some embodiments, the thickness profile is about 1 mm to about 90 mm. In some embodiments, the thickness profile is about 1 mm to about 100 mm. In various embodiments, as will be discussed below, the adapter 100 is sized to sit within a well of an open well flow cell (e.g., formed by a cassette, a gasket, and a glass slide). In various embodiments, the adapter is shaped to provide an opening between the adapter and the complementary walls of the well. This disclosure does not seek to limit the dimensions of adapter, and one of ordinary skill in the art would appreciate the adapter body 104 may include any suitable planform dimensions depending on the open well into which it is inserted. In various embodiments, the adapter 100 may be expandable (e.g., telescoping) or adjustable in size.

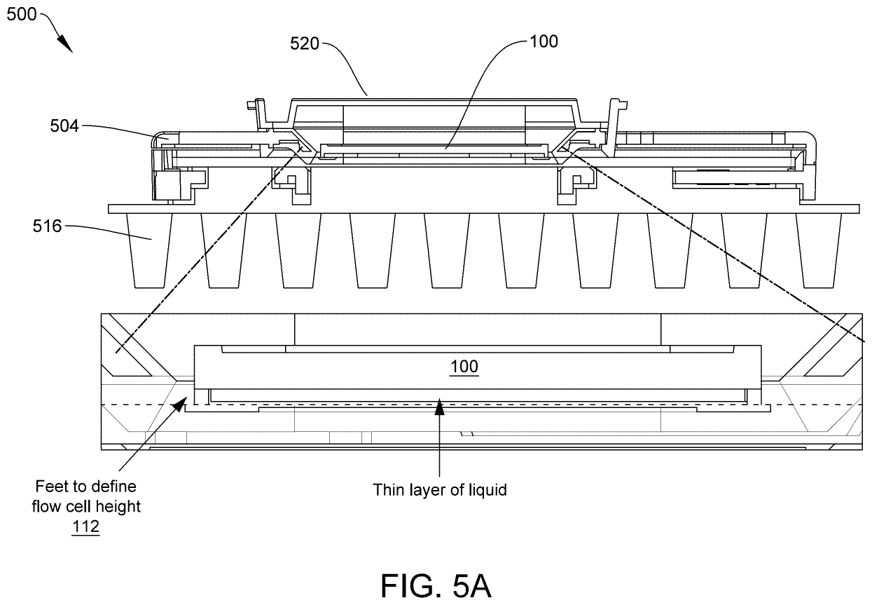

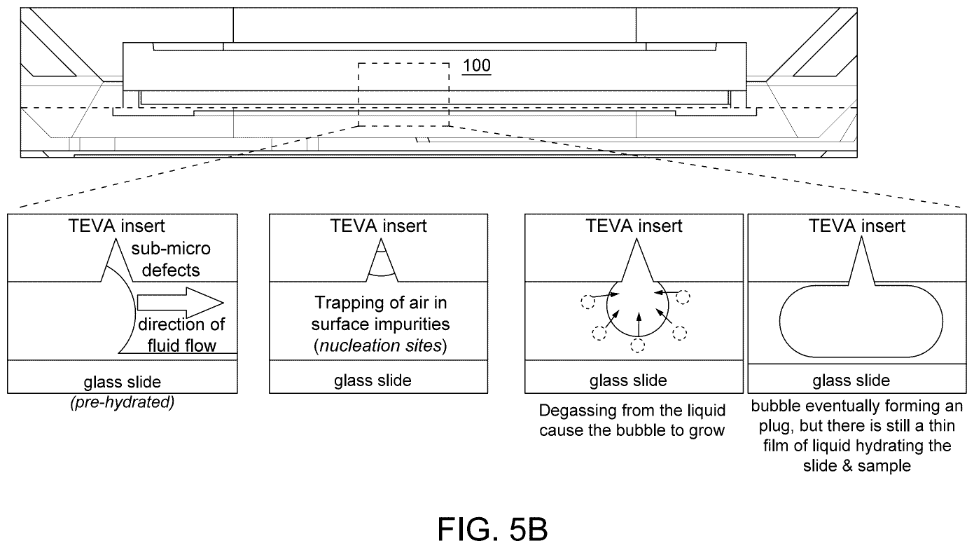

In various embodiments, the adapter 100 is formed as a single unitary component. In various embodiments, the adapter 100 is formed as an assembly of disparate components coupled to one another, such as by chemical adhesive, epoxy, joinery or other mechanical fasteners. In various embodiments, the adapter 100 is formed from translucent or transparent material. In various embodiments, the adapter 100 is formed from material configured to allow light of a predetermined wavelength (or spectrum of wavelengths) to pass through, thereby forming transparency or translucence over one or more bands of the electromagnetic spectrum. In various embodiments, the adapter 100 is formed from injection molding, additive manufacturing (such as 3D printing) and/or machining techniques (e.g., milling, lathing, drilling, etc.). In various embodiments, the adapter 100 is formed from one or more elastomers, natural or synthetic rubbers, plastics, glass, ceramic or other composites, metal, metal alloy, or another material, alone or in combination (e.g., a base material over-molded with a polymer, such as silicone). In various embodiments, if the adapter 100 is formed from a material having surface imperfections in the lower surface, the surface imperfections may trap bubbles in the liquid dispensed underneath the adapter 100. In particular, the bubbles may form and/or be trapped and directed upward towards the lower surface of the adapter 100. In various embodiments, high wettability of the tissue and/or slide ensures that a liquid layer is present between the bubble and the tissue and/or slide (as shown in FIGS. 5A-5B). In various embodiments, surface smoothness of the lower surface of the adapter is engineered to suppress bubble nucleation. For example, a glass adapter made of a flat piece of glass and shims as feet may reduce or prevent bubble formation when comparted to adapters made of other materials (e.g., injection molded polymer). In various embodiments, manufacturing process affects surface quality and, thus, also affects bubble formation. In various embodiments, feet are formed by etching a glass adapter. In various embodiments, feet are formed by attaching elastomeric or plastic feet onto a glass adapter, for example, via adhesives or by overmolding.

In various embodiments, the body portion 104 or any portion of adapter 100 is coated in one or more compounds, including compounds that increase hydrophilicity or increase hydrophobicity of a surface (e.g., lower surface, upper surface, side surfaces) of the adapter 100. In various embodiments, the surface that contacts the reagent(s) within the flow cell is coated with one or more coatings as described above. In various embodiments, adapter 100 is not coated with any surface coatings. In various embodiments, the body 104 is formed using a porous material, such that air or other gases may permeate through the body 104, but not liquids. In various embodiments, the material selected is naturally have gas permeable even when the body 104 is formed as a continuous (e.g., solid) block. In various embodiments, openings are formed in the body 104 or other portions of the adapter 100 to convey gasses therethrough but maintain the liquid trapped underneath the adapter 100.

With continued reference to FIG. 1A, the adapter 100 includes a perimeter portion 108 surrounding the body 104. In various embodiments, the perimeter portion 108 is planar with the upper and lower surfaces of the body, thereby forming a planar perimeter surrounding the body portion 104. In various embodiments, the perimeter portion 108 includes raised lip extending above the upper surface. In various embodiments, the lip of the perimeter portion 108 extends from the upper surface of body 104 at a right angle relative to the horizontal. In various embodiments, the lip of the perimeter portion extends from the upper surface at a non-perpendicular angle relative to the horizontal, such as an oblique angle to form an upward and outwardly extending lip with a frustoconical interior shape. In various embodiments, the perimeter portion 108 forms a planar edge of body 104. In various embodiments, the lip of the perimeter portion 108 forms a recess that is configured to receive and hold a predetermined amount of liquid (e.g., water). After the adapter 100 is inserted into the open well and reagents are dispensed inside the reversibly-formed closed flow cell, the liquid in the recess can serve to reduce (e.g., prevent) evaporation of the reagents within the closed flow cell (e.g., during thermocycling).

In various embodiments, the edge of body 104 is formed with another cross-sectional shape, such as rounded or diagonal. In various embodiments, the edge of the body 104 is formed such that upper surface has a smaller surface area than the lower surface, the edge extending diagonally from the upper surface to the extended outer surface or vice versa. In various embodiments, the perimeter portion 108 includes a chamfered or filleted edge. In various embodiments, any edge or point where two or more contours come together may be chamfered, filleted or rounded in order to reduce sharp edges formed by the adapter 100. In various embodiments perimeter portion 108 includes a draft angle, such as a draft angle of 1-10 degrees.

With continued reference to FIGS. 1A-1D, adapter 100 includes a plurality of feet 112 extending from the lower surface of the body 104. In various embodiments, the plurality of feet is spaced about the perimeter portion 108 of the lower surface. In various embodiments, the plurality of feet 112 are equally spaced about the perimeter portion 108. In various embodiments, the plurality of feet 112 includes a non-uniform spacing between said feet 112 about the perimeter portion 108 of the adapter. In various embodiments, the plurality of feet 112 are numbered per side of the adapter 100. For example, two feet 112 may be spaced about the long sides of the adapter 100 and a single foot centrally located on each of the short sides of the adapter 100. In various embodiments, the single foot extends a longer distance than the two/double feet. In various embodiments, a single continuous foot circumscribes the perimeter portion 108 of the lower surface. In various embodiments, the continuous foot or lower lip includes at least one opening or a notch. In various embodiments, each foot 112 of the plurality of feet include an inner edge and an outer edge. As shown in FIG. 1A, the outer edge of each foot is coplanar with the side or edge of the adapter 100, that is to say that the feet 112 do not extend radially further than the planform edge of the adapter 100.

Additionally or alternatively, as shown in FIGS. 1F and 1J, the plurality of feet 112 includes an outer edge that extends radially outward from the edge of the adapter 100, such that the feet extend both perpendicularly downward from the lower surface, and also radially outward form the edge of the adapter 100. As shown in FIG. 1J, the radially outwardly extending feet 112 may interfere, as shown at reference numeral 115, with a gasket disposed about the perimeter of the well of a cassette, to be described below. In various embodiments, a trench is disposed between the perimeter of the adapter 100 and the well wall, as shown a reference numeral 113 in FIG. 1I.

Additionally or alternatively, as shown in FIG. 1F, the feet 112 include a rounded cross section shape, such that the feet 112 meet the edge of adapter 100 proximate a cylindrical axis of the foot. In various embodiments, a cylindrical sidewall of each foot extends both downward from the lower surface of the body 104 and outwardly from the perimeter of the adapter 100. In various embodiments, each foot 112 includes a cross-section shape including rectilinear, circular, oblong, or more complex contoured polygons.

In various embodiments, each foot 112 of plurality of feet is configured to extend from the lower surface of the body 104 equidistantly, thereby forming a chamber underneath the adapter 100 when the feet 112 contact a flat surface, such as a glass slide forming a bottom surface of a well of an open well flow cell. In various embodiments, the feet 112 are configured to abut or rest upon the tissue slide directly. In various embodiments, the feet 112 are configured to be positioned beyond the boundary of the slide so as to avoid contact with the slide and instead abut against the structure (e.g. protruding shelf) of the cassette.

In various embodiments, each of the plurality of feet 112 extend a vertical distance of about 1 μm to about 2 mm from the lower surface. In various embodiments, each of the plurality of feet 112 extend a vertical distance of about 1 μm to about 1 mm from the lower surface. In various embodiments, each of the plurality of feet 112 extend a vertical distance of about 1 μm to about 900 μm from the lower surface. In various embodiments, each of the plurality of feet 112 extend a vertical distance of about 1 μm to about 800 μm from the lower surface. In various embodiments, each of the plurality of feet 112 extend a vertical distance of about 1 μm to about 700 μm from the lower surface. In various embodiments, each of the plurality of feet 112 extend a vertical distance of about 1 μm to about 600 μm from the lower surface. In various embodiments, each of the plurality of feet 112 extend a vertical distance of about 1 μm to about 500 μm from the lower surface. In various embodiments, each of the plurality of feet 112 extend a vertical distance of about 1 μm to about 400 μm from the lower surface. In various embodiments, each of the plurality of feet 112 extend a vertical distance of about 1 μm to about 300 μm from the lower surface. In various embodiments, each of the plurality of feet 112 extend a vertical distance of about 1 μm to about 200 μm from the lower surface. In various embodiments, each of the plurality of feet 112 extend a vertical distance of about 10 μm to about 1 mm from the lower surface. In various embodiments, each of the plurality of feet 112 extend a vertical distance of about 10 μm to about 900 μm from the lower surface. In various embodiments, each of the plurality of feet 112 extend a vertical distance of about 10 μm to about 800 μm from the lower surface. In various embodiments, each of the plurality of feet 112 extend a vertical distance of about 10 μm to about 700 μm from the lower surface. In various embodiments, each of the plurality of feet 112 extend a vertical distance of about 10 μm to about 600 μm from the lower surface. In various embodiments, each of the plurality of feet 112 extend a vertical distance of about 10 μm to about 500 μm from the lower surface. In various embodiments, each of the plurality of feet 112 extend a vertical distance of about 10 μm to about 400 μm from the lower surface. In various embodiments, each of the plurality of feet 112 extend a vertical distance of about 10 μm to about 300 μm from the lower surface. In various embodiments, each of the plurality of feet 112 extend a vertical distance of about 10 μm to about 200 μm from the lower surface. In various embodiments, each of the plurality of feet 112 extend a vertical distance of about 100 μm to about 1 mm from the lower surface. In various embodiments, each of the plurality of feet 112 extend a vertical distance of about 100 μm to about 900 μm from the lower surface. In various embodiments, each of the plurality of feet 112 extend a vertical distance of about 100 μm to about 800 μm from the lower surface. In various embodiments, each of the plurality of feet 112 extend a vertical distance of about 100 μm to about 700 μm from the lower surface. In various embodiments, each of the plurality of feet 112 extend a vertical distance of about 100 μm to about 600 μm from the lower surface. In various embodiments, each of the plurality of feet 112 extend a vertical distance of about 100 μm to about 500 μm from the lower surface. In various embodiments, each of the plurality of feet 112 extend a vertical distance of about 100 μm to about 400 μm from the lower surface. In various embodiments, each of the plurality of feet 112 extend a vertical distance of about 100 μm to about 300 μm from the lower surface. In various embodiments, each of the plurality of feet 112 extend a vertical distance of about 100 μm to about 250 μm from the lower surface. In various embodiments, each of the plurality of feet 112 extend a vertical distance of about 100 μm to about 200 μm from the lower surface. In various embodiments, each of the plurality of feet 112 extend a vertical distance of about 150 μm to about 200 μm from the lower surface. In various embodiments, each of the plurality of feet 112 extend a vertical distance of about 180 μm from the lower surface. One of ordinary skill in the art would appreciate that to adjust the volume of the chamber formed underneath the adapter 100 (i.e. space between the underside of the adaptor and slide containing the biological sample), the feet 112 may be adjusted in order to lower or raise the adapter 100 off of the platform (e.g., glass slide) on which it stands. This disclosure does not seek to limit the size and shape of the feet 112, and therefore the volume captured underneath the adapter 100. For example, and without limitation, the adapter 100 and the feet 112 may be sized to define a chamber having a volume of 10-1000 μL. Preferably, the adapter 100 and the feet 112 are sized to define a chamber having a volume of 100-500 μL. In various embodiments, when inserted into an open well flow cell, the adapter 100 and the feet 112 define a chamber having a volume of 10, 20, 30, 40, 50, 60, 70, 80, 90, or 100 μL, for example. In various embodiments, the adapter 100 is configured to reduce the overall volume of liquid required to fill the well of an open well flow cell and fully submerge a sample disposed within the well.

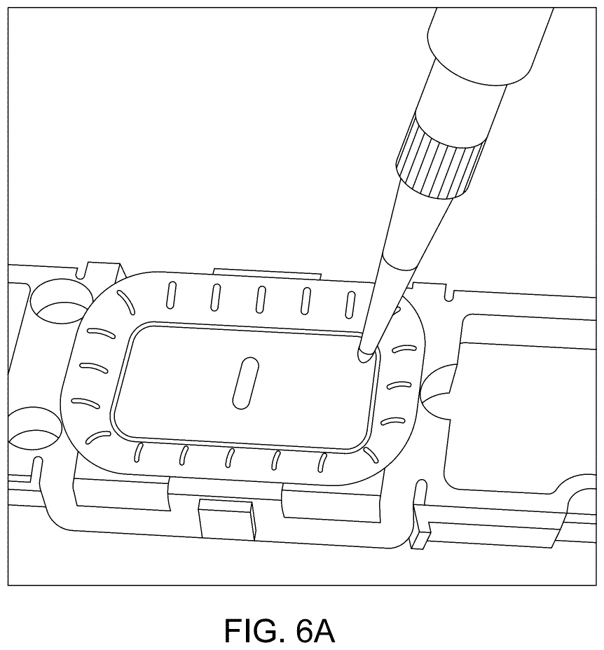

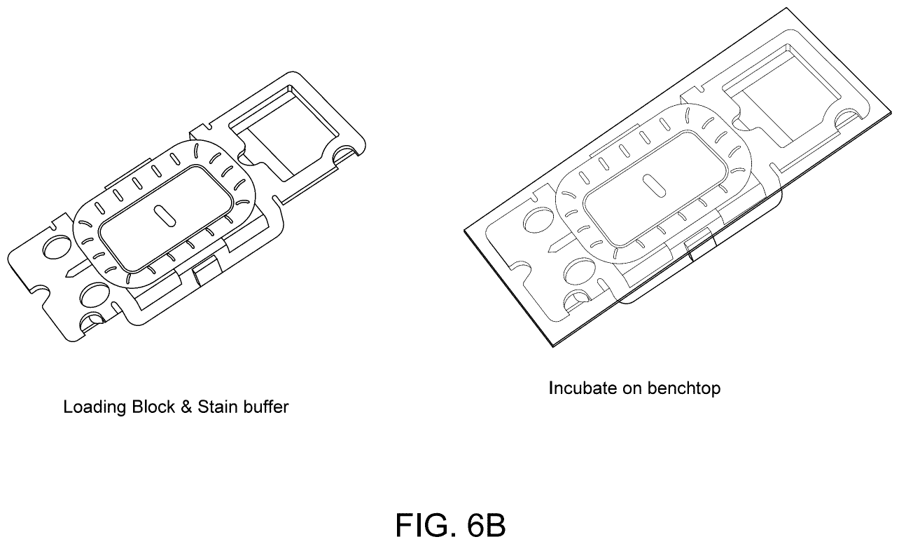

With continued reference to FIG. 1A, adapter 100 includes an inlet 116. In various embodiments, the inlet 116 is an opening (e.g., a through hole) formed through the adapter 100 that fluidly connects the upper surface and lower surface of the body 104. In various embodiments, the inlet 116 is formed as one or more notches or one or more recesses in the perimeter portion 108 (and/or extending into the body), as shown in FIG. 1A. For example, the adapter may include an undulating profile along the perimeter (undulating in the plan form view) with one or more peaks (e.g., one peak at the center of each of the short sides) thereby forming two or more inlets and/or two or more outlets when the adapter 100 is positioned within the open well. In various embodiments, the inlet 116 is formed in a corner of the adapter 100. In various embodiments, the inlet 116 is formed as a notch having a curvilinear edge. In various embodiments, the curvilinear edge of the inlet 116 is formed at a right angle to the perimeter portion 108. In various embodiments, the curvilinear edge of the inlet 116 is formed at a corner of the adapter 100, and the raised lip of the perimeter portion 108 running along the curvilinear edge, as shown in FIG. 1A. In various embodiments, the lip is cut off at the notch of inlet 116 (i.e., there is no lip around the notch), or extend around said notch or opening, in various embodiments. In various embodiments, the inlet 116 is sized to receive a tip of a pipette (as shown in FIGS. 6A-6B).

In various embodiments, the inlet 116 is configured to provide access to the lower surface of the adapter 100 from a position above the upper surface of adapter 100, allowing for dispensing of liquid to the underside of the adapter 100, to fill the volume of the now-closed flow cell, by a user handling a pipette. In various embodiments, the inlet 116 is disposed along the perimeter portion 108 of adapter 100. In various embodiments, the inlet 116 is disposed along a linear edge of the perimeter portion 108. For example, and without limitation, the inlet 116 is disposed at a central location between two corners of the perimeter portion 108. In another example, the inlet 116 is disposed along a short edge or a long edge of the rectangular-shaped adapter 100. In various embodiment, the inlet 116 is formed as a notch (e.g., a circular cutout) in perimeter portion 108, similar to FIG. 1A, with the curvilinear edge of the inlet 116 cut out of a substantially linear side of the adapter 100. In various embodiments, inlet 116 includes one or more chamfers, fillets or other edge features configured to direct liquid underneath the adapter 100. For example, and without limitation, inlet 116 may be configured with a plurality of small channels formed (e.g., machined) therein, the plurality of channels configured to evenly disperse the liquid from the inlet evenly along the lower surface of the adapter 100.

In various embodiments, a smooth surface of the inlet 116 can avoid risk of damaging the pipette to be inserted therein, and further serve as a funnel or guide to receive the pipette and align the nozzle with the orifice of the inlet for precise dispensing of the reagent(s)—thereby avoid spilling and further reducing the amount of reagent needed for a given sample tissue analysis.

In various embodiments, the inlet 116 is formed as an opening through the body portion 104, as shown in FIGS. 1E, 1F, 1G, 1H and 1I. In various embodiments, one or more inlets are disposed within the adapter 100, thereby forming more than one opening through the body 104 into which reagents may be provided to the chamber underneath the adapter 100. In various embodiments, the opening is formed as a right cylinder bored through the body 104 having planar circular openings through the upper and lower surfaces respectively. In various embodiments, the inlet 116 is formed at an angle through body 104 of adapter 100, thereby dispensing liquid below the adapter 100 at a location different than the insertion location of the inlet 116 on the upper surface of the body 104. In various embodiments, the adapter 100 has more than one inlet 116 present and the more than one inlet 116 is configured to receive liquid sequentially or simultaneously. As shown in FIG. 1E, two inlets 116 are provided through the body 104 of the adapter 100, where each inlet 116 is configured to receive liquid. In various embodiments, inlets 116 is formed with any size or shape opening, such as a circular opening configured to receive the tip of a pipette. In various embodiments, a vacuum may be pulled from one inlet 116 to thereby draw liquid reagent through one or more different inlet(s) 116.

In various embodiments, inlet 116 includes a wall disposed about the inlet 116, as shown in FIG. 1G. In various embodiments, the wall is formed as a raised wall surrounding the opening of inlet 116 extending upward from the upper surface of body 104. In various embodiments, the raised wall forms a well around the inlet 116, for example, to capture liquid reagent that misses the inlet 116. In various embodiments, the wall is formed as a square or rectangular wall extending inwardly from the lip and circumscribing the inlet 116. In various embodiments, the inlet may have any suitable planform shape, including circular or another polygonal shape. In various embodiments, the raised wall vertically extends the same distance as the lip circumscribing the perimeter portion 108. In various embodiments, the inlet 116 is formed in a corner of the adapter 100, such as an arcuate notch extending through the body from the upper surface to the lower surface. In various embodiments, the inlet 116 includes a notch having a radius, extending from the arcuate corner. In various embodiments, no inlet is provided on the adapter 100. In an inlet-less embodiment, a user may provide a liquid reagent through the gap formed between the wall of the open well flow cell and the perimeter portion of the adapter 100.

With continued reference to FIG. 1A, the adapter 100 includes a protrusion 120. In various embodiments, the protrusion 120 is configured to serve as a handle or gripping feature to facilitate insertion and/or removal of the adaptor 100 into or out of the open well flow cell. Gripping of protrusion 120 can be performed via an automated (e.g. robotic) apparatus, or manually (e.g., via tweezers). In various embodiments, the protrusion 120 extends from the upper surface of body 104 a distance of about 1 mm to about 20 mm. In various embodiments, the protrusion 120 extends from the upper surface of body 104 a distance of about 1 mm to about 10 mm. In various embodiments, the protrusion 120 extends from the upper surface of body 104 a distance of about 1 mm to about 5 mm. In various embodiments, the protrusion 120 extends from the upper surface of body 104 a distance of about 5 mm to about 15 mm. In various embodiments, the protrusion 120 extends from the upper surface of body 104 a distance of about 5 mm to about 10 mm. In some embodiments, the protrusion 120 extends from the upper surface of the body a distance of about 10 mm to about 20 mm.

In various embodiments, the protrusion 120 extends perpendicularly to the planar upper surface of body 104. In various embodiments, the protrusion 120 is formed as generally elongate shape having a first end and a second end, extending a height above the upper surface of the body 104. In various embodiments, the elongate protrusion 120 is disposed laterally across the upper surface of body 104 extending parallel to the short side of the adapter 100. In various embodiments, the protrusion 120 is angled to extend along a longitudinal axis of adapter 100. In various embodiments, the protrusion 120 is angled diagonally across the adapter 100, such as extending at least a portion of the distance between opposite corners of the adapter 100. In various embodiments, the protrusion 120 includes a distal end spaced from the upper surface of the body 104 having a perpendicular sidewall extending therebetween. In various embodiments, the protrusion 120 includes a knob or other feature configured to facilitate grasping by forceps.

In various embodiments, the protrusion 120 is formed as a unitary component with body 104. In various embodiments protrusion 120 may be coupled to body 104, such as by chemical adhesion, joinery or mechanical fasteners. In various embodiments, protrusion 120 may include one or more openings such as a loop, allowing for forceps or a user's fingers to grasp underneath the topmost portion of the protrusion. In various embodiments, there may be more than one protrusion 120 extending from the upper surface of body 104. In various embodiments, each protrusion 120 may be identical or of varied geometry. In various embodiments, protrusion 120 may be sized in order to be grasped with forceps or a user's fingers and the adapter 100 lifted therewith. In various embodiments, the protrusion 120 extends to a height less than the height of the open well flow cell such that the top surface of the protrusion 120 is below the top plane of the open well flow cell, and a user can apply a layer of polymerase chain reaction (PCR) tape to extend across the entire well of the flow cell without interference by the protrusion(s) 120. In various embodiments, the adapter 100 does not include any protrusion on the upper surface of the body. To insert and remove such an adapter, a user may couple an adhesive tape to the adapter and insert and/or remove the adapter using the adhesive tape.

Referring now to FIGS. 1G and 1H, in various embodiments, the adapter 100 includes one or more reinforcement feature 124 configured to increase rigidity of the adaptor (e.g., to prevent or inhibit deformation during thermal cycling or handling of the flow cell). In various embodiments, the reinforcement feature 124 is formed as a rib on the upper surface of the body 104, extending at least partially over the body 104 (e.g., from a central protrusion to a perimeter portion 108). In various embodiments, the reinforcement feature 124 extends from a centrally located protrusion 120 to a raised lip disposed along the perimeter portion 108. In various embodiments, the reinforcement feature 124 is formed as a rib extending from the upper surface of body 104. In various embodiments, the reinforcement feature 124 extends longitudinally or laterally across the body 104. In various embodiments, the reinforcement feature 124 extends in a lattice structure from a raised lip disposed along the perimeter portion 108. One of skill in the art would appreciate that the reinforcement feature 124 may be disposed at any angle and with any appropriate repetition to suitably stiffen the adapter 100 and prevent deformation due to heat or force applied thereto. In various embodiments, the reinforcement feature 124 is formed as a unitary structure with the body 104 or applied after manufacture. In various embodiments, the reinforcement feature 124 is internal to the body 124 and extends between the upper surface and the lower surface of the body 104. As shown in FIG. 1K, the reinforcement feature 124 may be formed in a “X” pattern disposed on the upper surface of the body 104. In various embodiments, the reinforcement feature 124 is formed as a cross having perpendicularly intersecting ribs. One of skill in the art would appreciate that there may be any suitable arrangement of raised ribs disposed on the body 104 in order to appropriately stiffen the adapter 100 along one or both of the longitudinal or lateral axes.

As shown in FIG. 1L, an adapter 100 is shown in perspective and cross-sectional views with a non-planar lower surface. The non-planar lower surface as shown in FIG. 1L includes a varying thickness profile from one edge of body 104 to the opposite edge of the body 104. In various embodiments, the thickness profile includes a first thickness at the first and second edges of the body 104 (the first and second edges being at the perimeter portion 108) and a second thickness that is greater than the first thickness at a central portion of the body 104 (at a midpoint between the first and second edges). In various embodiments, the thickness profile increases from the first thickness to the second thickness at a constant rate. In various embodiments, the thickness profile increases from the first thickness to the second thickness at a non-linear rate (as shown in FIG. 1L). In various embodiments, a cross-section of the body includes a first end opposite a second end and a midpoint therebetween, wherein the thickness profile of the body increases in thickness from the first end to the midpoint and decreases in thickness from the midpoint to the second end.

In various embodiments, the non-planar lower surface of adapter 100 is configured to pull a liquid thereunder via capillary action. In various embodiments, one or more liquid (e.g., reagent) is dispensed along the perimeter portion 108 and the liquid is directed towards the smaller space at the central portion of the body 104, where the tissue sample may be located on the underlying slide to ensure the tissue sample is completely wetted or submersed within the (lower overall quantity) of reagent(s). In various embodiments, the lower surface of adapter 100 may include any variation of thickness in order to form a variable volumetric space between the adapter and the floor of the well on which the adapter 100 sits. In various embodiments, the lower surface of the adapter may be lower proximate a first end than a second end, forming a lower surface therebetween. In various embodiments, the adapter 100 has a lower surface that extends lower proximate the perimeter portion 108 than a central portion of the body 104, forming a domed or vaulted lower surface of the adapter. By forming a non-planar lower surface, the direction in which liquid is directed via capillary action, travelling from a greater volumetric space to a smaller volume via capillary forces.

Referring now to FIG. 2, bottom planform views of adapter 100 are depicted showing dispersion of liquid underneath said adapter in the well of a cassette. FIG. 2 depicts liquid dispersed along the underside of the adapter 100 in various dispensing volumes, specifically, 60 uL, 70 uL, and 80 uL. As can be seen from the FIG. 2, the greater the volume of dispensed liquid, the further said liquid is spread underneath the adapter, where the 60 uL does not reach the perimeter portion 108 of the adapter 100, shown circled. Illustrated is the ability of the adapter 100 to disperse a smaller volume of liquid (e.g., a reagent) throughout the well than would be possible without the adapter inserted.

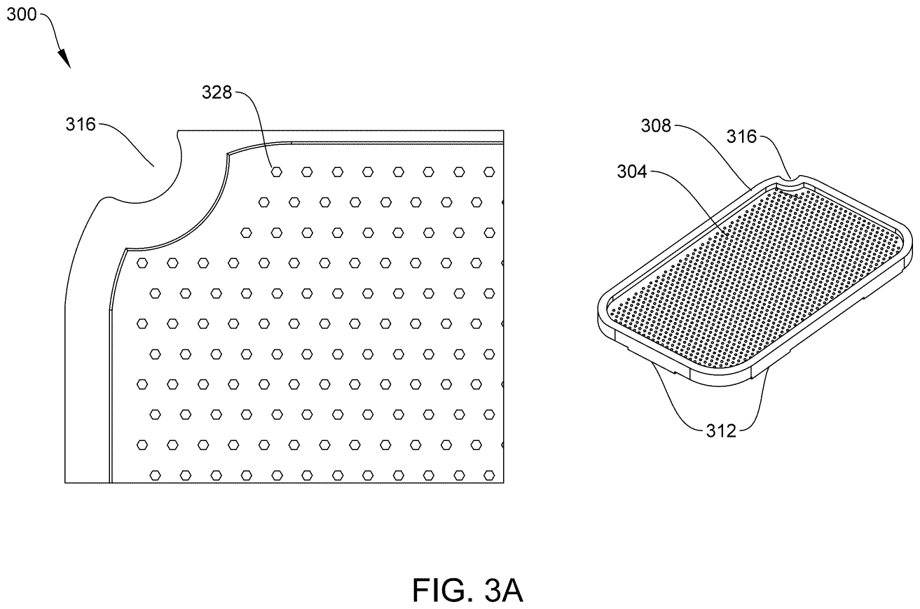

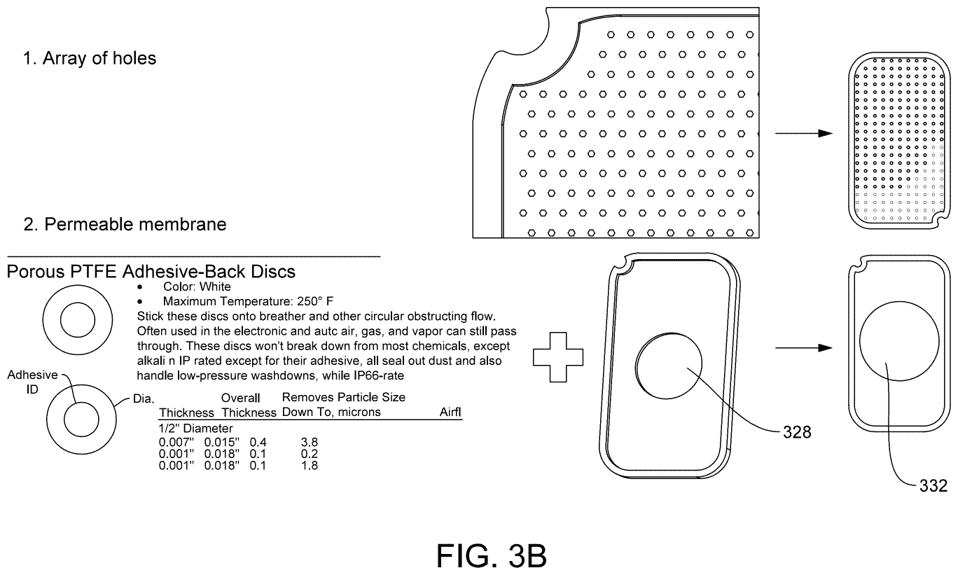

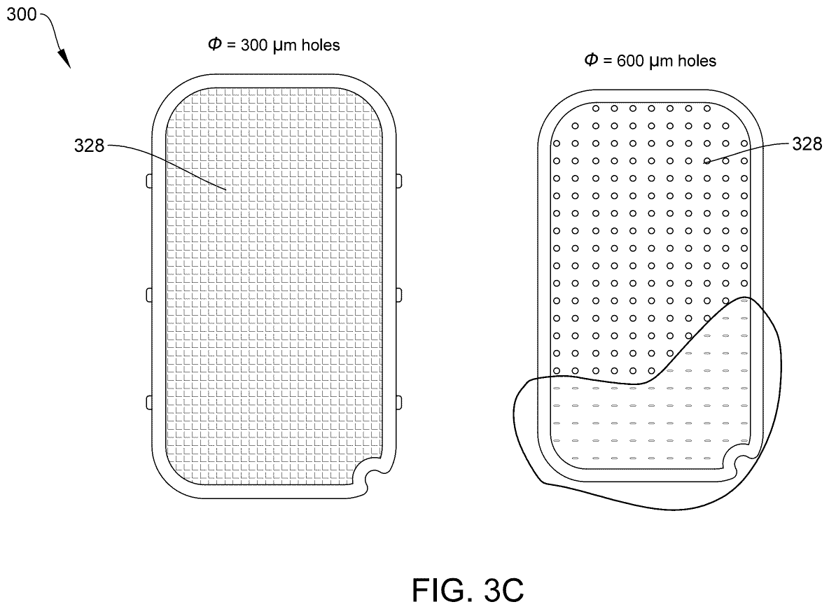

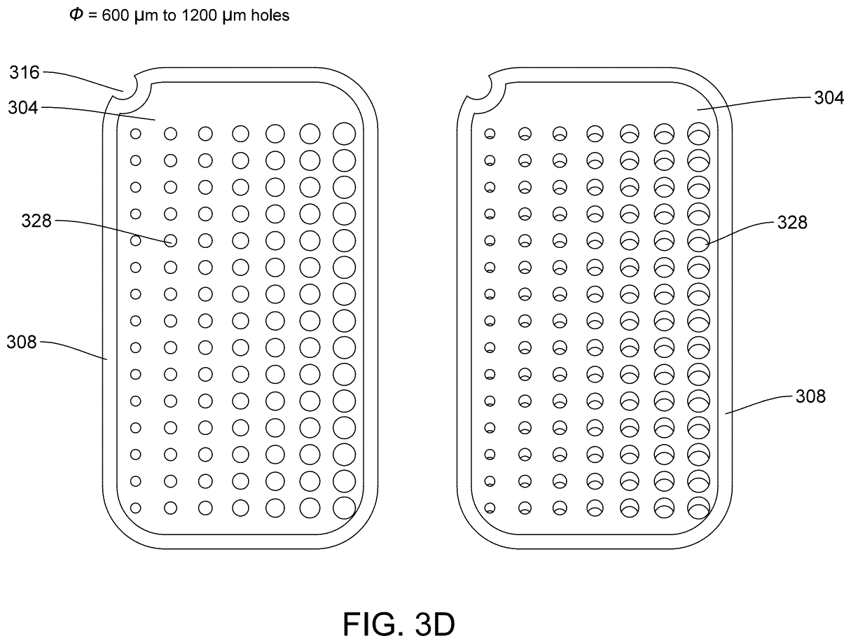

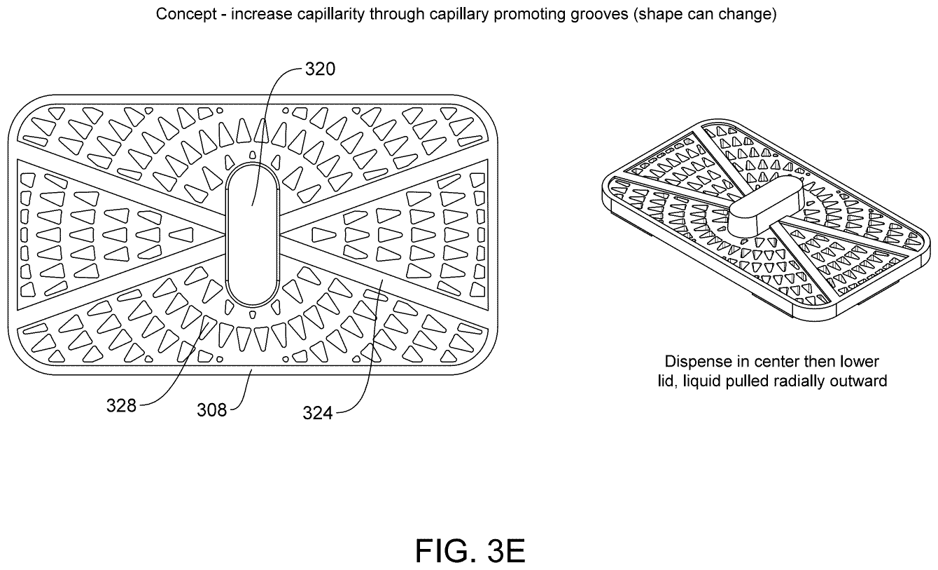

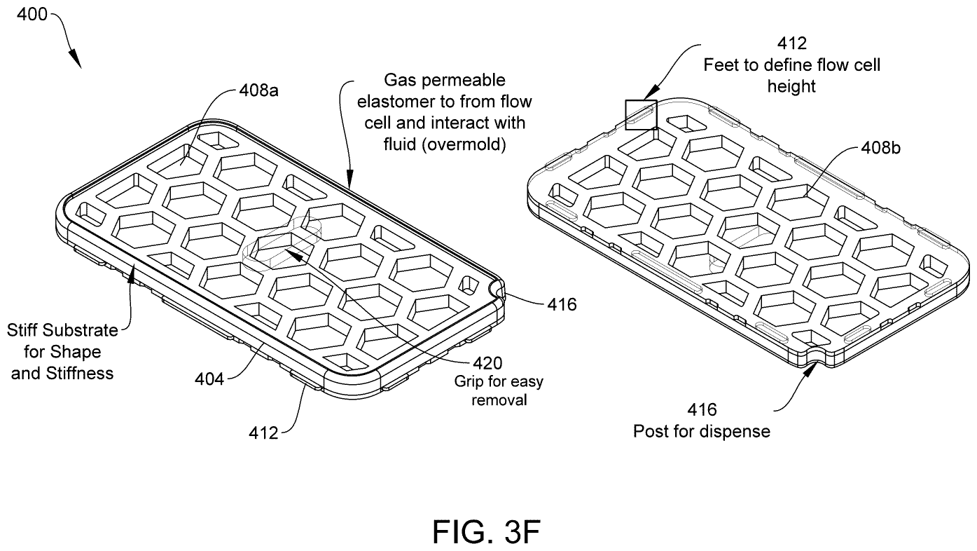

Referring now to FIG. 3A, an adapter 300 is shown in perspective and detail planform views. As shown in FIG. 3A, the adapter 300 includes a body portion 304 formed from generally planar upper and lower surfaces, defining a thickness profile therebetween. In various embodiments, the upper and lower surfaces are generally rectilinear in planform shape. In various embodiments, the body portion 304 includes squared or right-angle corners, including four corners. In various embodiments, body portion 304 includes chamfered or rounded/radiused corners. The corners of body portion 304 may include any suitable radius, including radii in which the overall body portion is oblong or circular in planform shape. In various embodiments, the body portion 304 may be generally rectangular, with a first and second short sides approximately 16 mm. In various embodiments, the body portion 304 includes a first and second long side extending from the first and second short side, each long side having any approximate length of 28 mm, for example. In various embodiments, the adapter 300 may include an approximate width of 15.5 mm and an approximate length of 27.5 mm, for example. In various embodiments, the adapter 300 is sized to sit within a well of an open well flow cell, such that the adapter can be sized to leave a gap between the adapter and the complementary walls of the well. This disclosure does not seek to limit the dimensions of adapter, and one of ordinary skill in the art would appreciate that the adapter body 304 may include any planform dimensions depending on the well into which it is inserted. In various embodiments, the adapter 300 is expandable or adjustable in size.

With continued reference to FIG. 3A, the adapter 300 includes a perimeter portion 308 surrounding the body 304. In various embodiments, the perimeter portion 308 is planar with the upper and lower surfaces of the body, thereby forming a planar perimeter surrounding the body portion 304. In various embodiments, the perimeter portion 308 includes a raised lip extending above the upper surface. In various embodiments, the lip of the perimeter portion 308 extends from the upper surface of body 304 at a right angle relative to the horizontal. In various embodiments, the lip of the perimeter portion extends from the upper surface at a non-perpendicular angle relative to the horizontal, such as an oblique angle to form an upward and outwardly extending lip with a frustoconical interior shape. In various embodiments, the perimeter portion 308 forms a planar edge of body 304. In various embodiments, the edge of body 304 may be formed with another cross-sectional shape, such as rounded or diagonal. In various embodiments, the edge of the body 304 is formed such that upper surface has a smaller surface area than a surface area of the lower surface, the edge extending diagonally from the upper surface to the extended outer surface or vice versa. In various embodiments, the perimeter portion 308 includes a chamfered or filleted edge. In various embodiments, any edge or point where two or more contours come together may be chamfered, filleted or rounded in order to reduce sharp edges formed by the adapter 300. In various embodiments, the perimeter portion 308 includes a draft angle, such as a draft angle of about 1 to about 10 degrees.

With continued reference to FIG. 3A, adapter 300 includes a plurality of feet 312 extending from the lower surface of the body 304. The adaptor of the embodiment in FIGS. 3A-3F can include similar feet as described in connection with the embodiments of FIGS. 1A-1L. In various embodiments, the plurality of feet 312 are spaced about the perimeter portion 308 of the lower surface. In various embodiments, the plurality of feet 312 are equally spaced about the perimeter portion 308. In various embodiments, the plurality of feet 312 includes a uniform spacing between said feet 312 about the perimeter portion 308 of the adapter. In various embodiments, the plurality of feet 312 are numbered per side of the adapter 300. For example, two feet 312 may be spaced about the long sides of the adapter 300 and a single foot centrally located on each of the short sides of the adapter. In various embodiments, a single continuous foot circumscribes the perimeter portion 308 of the lower surface. In various embodiments, the continuous foot or lower lip includes at least one opening therein. In various embodiments, each foot 312 of the plurality of feet includes an inner edge and an outer edge. As shown in FIG. 3A, the outer edge of each foot is coplanar with the edge of the adapter 300, that is to say that the feet 312 do not extend radially further than the planform edge of the adapter 300. In various embodiments, the plurality of feet 312 may include an outer edge that extend radially outward from the edge of the adapter 300, such that the feet extend both perpendicularly downward from the lower surface and also radially outward form the edge of the adapter 300. In various embodiments, the radially outwardly extending feet 312 may interfere with a gasket disposed about the perimeter of the well of a cassette, to be described below. In various embodiments, there may be a trench disposed between the perimeter of the adapter 300 and the well wall.

Additionally or alternatively, the plurality of feet 312 includes a rounded cross section shape, such that the feet 312 meet the edge of adapter 300 proximate a cylindrical axis of the foot, the cylindrical sidewall of each foot extending both downward from the lower surface of the body 304 and outwardly from the perimeter of the adapter 300. Each foot 312 may include any cross-section shape including rectilinear, circular, oblong, or more complex contoured polygons, in various embodiments.

In various embodiments, each foot 312 of plurality of feet is configured to extend from the lower surface of the body 304 equidistantly, thereby forming a chamber underneath the adapter 300 when the feet 312 contact a flat surface, such as a glass slide forming a bottom surface of a well of an open well flow cell. One of ordinary skill in the art would appreciate that to adjust the volume of the chamber formed underneath the adapter 300, the height of the feet 312 may be adjusted in order to lower or raise the adapter 300 off of the platform (e.g., glass slide) on which it stands. This disclosure does not seek to limit the size and shape of the feet 312, and therefore the volume captured underneath the adapter 300. For example, and without limitation, the adapter 300 and the feet 312 may be sized to define a chamber having a volume of 10-1000 μL. Preferably, the adapter 300 and the feet 312 are sized to define a chamber having a volume of 100-500 μL. In various embodiments, when inserted into an open well flow cell, the adapter 300 and feet 312 (similarly to the adaptor 100 described above) define a chamber having a volume of 10, 20, 30, 40, 50, 60, 70, 80, 90, 100, 200, or 300 μL, for example. In various embodiments, the adapter 300 may be configured to reduce the overall volume of liquid required to fill the well of an open well flow cell and fully submerge a sample disposed within the well.

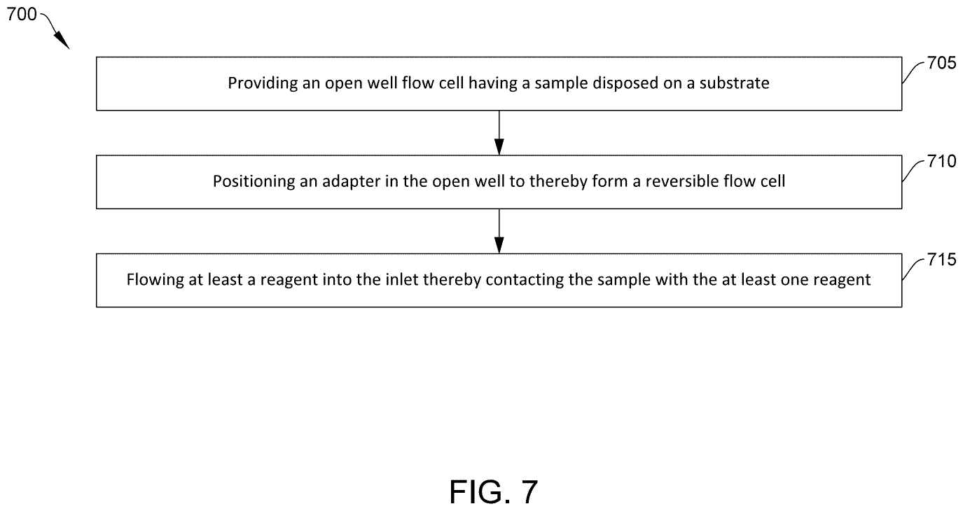

With continued reference to FIG. 3A, adapter 300 may include an inlet 316. In various embodiments, the inlet 316 is an opening formed through the adapter 300 that fluidly connects the upper surface and lower surface of the body 304. In various embodiments, the inlet 316 is formed as a notch or recess in the perimeter portion 308, as shown in FIG. 3A. In various embodiments, the inlet 316 is formed in a corner of the adapter 300. In various embodiments, the inlet 316 includes a notch having a curvilinear edge. In various embodiments, the curvilinear edge of the inlet 316 formed at a right angle to the perimeter portion 308. In various embodiments, the curvilinear edge of the inlet 316 may be formed at a corner of the adapter 300, and the raised lip of the perimeter portion 308 running along said curvilinear edge, as shown in FIG. 3A. In various embodiments, the lip is cut off at the notch of the inlet 316 (i.e., there is no lip around the notch), or extend around said notch or opening, in various embodiments. In various embodiments, the inlet 316 is sized to receive a tip of a pipette (as shown in FIGS. 7A-7B).

In various embodiments, the inlet 316 is configured to provide access to the lower surface of the adapter 300 from a position above the upper surface of adapter 300, allowing for dispensing of liquid to the underside of the adapter 300 by a user handling a pipette. In various embodiments, the inlet 316 is disposed along the perimeter portion 308 of adapter 300. In various embodiments, the inlet 316 is disposed along a linear edge of the perimeter portion 308. For example, and without limitation, the inlet 316 is disposed at a central location between two corners of the perimeter portion 308. In another example, the inlet 316 is disposed along a short edge or a long edge of the rectangular-shaped adapter 300. In various embodiment, the inlet 316 is formed as a notch (e.g., circular cutout) in perimeter portion 308, similar to FIG. 3A, with the curvilinear edge of the inlet 316 cut out of a substantially linear side of the adapter 300. In various embodiments, the inlet 316 includes one or more chamfers, fillets or other edge features configured to direct liquid underneath the adapter 300. For example, and without limitation, the inlet 316 may be configured with a plurality of small channels formed (e.g., machined) therein, the plurality of channels configured to evenly disperse the liquid from the inlet 316 evenly along the lower surface of the adapter 300.

In various embodiments, adapter 300 includes one or more reinforcement feature 324. In various embodiments, the reinforcement feature is formed as a rib on the upper surface of the body 304, extending at least partially over the body 304 (e.g., from a central protrusion to a perimeter portion 308). In various embodiments, the reinforcement feature 324 extends from a centrally located protrusion 320 to a raised lip disposed along the perimeter portion 308. In various embodiments, the reinforcement feature 324 is formed as a raised rib extending from the upper surface of body 304. In various embodiments, the reinforcement feature 324 extends longitudinally or laterally across the body 304. In various embodiments, reinforcement feature 324 may fully extend in a lattice structure from a raised lip disposed along the perimeter portion 308. One of skill in the art would appreciate that the reinforcement feature 324 may be disposed at any angle and with any appropriate repetition to suitably stiffen the adapter 300 and prevent deformation due to heat or force applied thereto. In various embodiments, the reinforcement feature 324 is formed as a unitary structure with the body 304 or applied after manufacture. In various embodiments, the reinforcement feature 324 is internal to the body 324 and extends between the upper surface and the lower surface of the body 304. In various embodiments, reinforcement feature 324 is formed in a “X” pattern disposed on the upper surface of the body 304. In various embodiments, the reinforcement feature 324 is formed as a cross having perpendicularly intersecting ribs. One of skill in the art would appreciate that there may be any suitable arrangement of raised ribs disposed on the body 304 in order to appropriately stiffen the adapter 300 along one or both of the longitudinal or lateral axes.

In various embodiments, body portion 304 includes a plurality of openings 328 formed therein. In various embodiments, the plurality of openings 328 is formed within the body portion 304 in a grid pattern in parallel rows and columns over the surface area of body portion 304. In various embodiments, there may be any suitable number of openings 328 extending from the upper surface to the lower surface of body 304. In various embodiments, each opening 328 is formed as a through-hole extending perpendicularly from the upper surface to the lower surface of the body 304. In various embodiments, the openings 328 are formed with linear or faceted sides, e.g., forming a hexagonal through-hole, as shown in the exemplary embodiment of FIG. 3A. In various embodiments, each opening 328 is approximately cylindrical, extending perpendicularly through body 304. In various embodiments, each opening is approximately 0.15 mm in diameter. In various embodiments, the openings 328 have a random distribution across the body 304. In various embodiments, each opening 328 of the plurality of openings are equally sized, as shown in FIG. 3A.

In various embodiments, because bubbles may form at nucleation sites on the lower surface of the adapter (e.g., due to degassing of gas trapped in the liquid or due to phase change, specifically evaporation, occurring during thermal cycling or incubation), the plurality of openings 328 serve as an outlet to conduct gas from the liquid dispensed underneath adapter 300 to the exterior environment. FIGS. 5A-5B depict the formation of bubbles at nucleation sites (e.g., on the lower surface of the adaptor lid). Thus, the openings 328 permit gas to released from liquid reagent(s) underneath the adapter 300 and pass through the adaptor. In various embodiments, the openings 328 are located at certain predetermined portions of adapter 300. In various embodiments, the openings 328 are formed at a central location of the adapter 300. In various embodiments, the openings 328 are formed along the perimeter portion 308 of the adapter 300. As shown in FIG. 3D, the plurality of openings 328 are formed with varying size across the adapter 300. For example, and without limitation, the plurality of openings 328 may gradually expand (e.g., become larger in size) across the body 304. For example, and without limitation, the plurality of openings 328 may have a size (e.g., diameter) of approximately 600 μm proximate one side of the adapter 300 and then expand to a size of approximately 1200 μm proximate a second side of the adapter 300. For example, larger holes may be disposed proximate the center of the adapter 300 circumscribed by smaller holes proximate the edges of adapter 300.

In various embodiments, the adapter 300 may be formed with the plurality of openings 328, such as injection molding or additive manufacturing, such as 3D printing. In various embodiments, the plurality of openings may be machined in the adapter 300, such as, for example, in a drill press, multi-axis milling machine, or the like. In various embodiments, the openings 328 are formed with any suitable opening shape and at any suitable angle. For example, the plurality of openings 328 may be formed at an angle relative to horizontal between the upper surface and the lower surface, such that the opening on the upper surface is not axially aligned with the opening in the lower surface of the same opening 328. Additionally, or alternatively, as shown in FIG. 3B, the adapter includes a single opening 328. In various embodiments, the single opening 328 is covered by a gas permeable membrane 332. In various embodiments, the gas permeable membrane 332 is configured to allow gas through the opening but seal against the body 304 in order to retain the liquid under the adapter 300. In some embodiments, the plurality of openings 328 as shown in FIGS. 3A-3B can also include a gas permeable membrane on the outer/upper surface of the adaptor. In various embodiments, all openings 328 are covered with the membrane 332. In various embodiments, a subset of the plurality of openings 328 are covered with the membrane 332.

Referring now to FIG. 3E, the adapter 300 is shown in planform and perspective views. In various embodiments, the plurality of openings 328 are formed in a plurality of concentric rings, disposed about a central portion of the body 304, such as around the protrusion 320. In various embodiments, each opening of the plurality of openings 328 are equally sized. In various embodiments, each opening of the plurality of openings 328 or each opening disposed in each ring varies in size. For example, and without limitation, each ring may include openings 328 of a first size (all rings in the first ring have an equal size), but openings of adjacent rings may be of variable size. For example, and without limitation, the plurality of openings 328 are formed in ascending size from the inner ring to the outermost ring of openings 328. In various embodiments, each concentric ring has an equal number of openings. In various embodiments, each successive ring emanating outwardly form the central portion of the body 104 has an increasing number of openings.

With continued reference to FIG. 3E, each opening of the plurality of openings 328 is formed with a triangular planform shape. In various embodiments, the openings 328 formed with any suitable planform shape (e.g., rectangular, square, trapezoidal, oval, circular, polygonal, etc.). In various embodiments, the openings 328 are formed by an approximately triangular planform shape having a base and an opposing vertex, interchangeably labeled as an apex. In various embodiments, the openings 328 are formed in concentric rings with the base of each opening oriented toward a centroid or centermost point of the body 104, with the apex of each opening oriented radially outward from the base. In various embodiments, the openings 328 are formed with the apex oriented towards a centroid of the body 104 and base oriented radially outward. In various embodiments, the orientation of the openings 328 is configured to disperse liquid disposed thereunder in a vector starting at the base of each opening and oriented toward the vertex of each opening. With reference to FIG. 3E, the liquid in the well may be dispensed prior to insertion of adapter 300, the adapter 300 then may be placed in the well having the liquid therein, the liquid may be forced to move radially outward in the direction of the apices of the openings 328. In various embodiments, the openings 328 are oriented with the apices inward, such that the liquid is forced to move inward along said openings 328. One of skill in the art would appreciate the orientation of the openings 328 may be manipulated to move liquid in any desired direction, including a plurality of directions. This disclosure does not seek to limit the orientation of these openings 328 and includes all orientations, the illustrative example in FIG. 3E is not limiting.

In accordance with another aspect of the disclosure, an additional or alternative feature to address bubble formation and provide a way to release gas within the liquid reagents is disclosed in FIG. 3F. FIG. 3F shows an overmolded adapter 400 in top perspective view and bottom perspective view. In various embodiments, the adapter 400 is a composite structure formed of a substrate having a first material and a skin having a second material. In various embodiments, the adapter 400 has the same dimensions as the adapters 100, 300 and is configured to be inserted into an open well flow cell to reduce a volume of liquid reagent required to fully contact a sample. In various embodiments, the adapter 400 includes a generally rectilinear shape. In various embodiments, the adapter 400 includes a substrate 404. In various embodiments, the substrate 404 has a generally rectilinear lip (e.g., made of a rigid material), similar to body 104, 304. In various embodiments, the substrate is made from a semi-rigid material (e.g., a semi-rigid polymer such as rubber). In various embodiments, the substrate 404 has a perimeter having two opposed shorter sides extending parallel to one another between two opposed longer sides. In various embodiments, the lip of the substrate 404 includes a perpendicular wall extending upwardly from the substrate forming a cavity between the lip and an internal framework. In various embodiments, the adapter 400 includes radiused corners, similar to adapter 100, 300. In various embodiments, the substrate 400 includes an internal framework extending between the perimeter portion of the substrate 404. In various embodiments, the internal framework is formed from a plurality of struts extending from each side substrate perimeter. As shown in adapter 400 of FIG. 3F, the internal framework of the substrate 404 includes a honeycomb pattern, having a plurality of struts connected within the perimeter portion of the substrate to form hexagonal openings therebetween. In various embodiments, the internal framework is a gridded pattern of struts. For example, in various embodiments, the internal framework may be a plurality of longitudinal struts and a plurality of lateral struts perpendicularly affixed to one another, forming square or rectangular openings therebetween. In various embodiments, the substrate 404 provides stiffness to the adapter 400 and also provides paths to allow gasses to pass through the openings in the internal framework.

With continued reference to FIG. 3F, the adapter 400 includes a first skin 408a on the substrate 404. In various embodiments, the skin 408a sits within the lip portion of substrate and over the internal framework. In various embodiments, the skin 408a is formed from silicone or another gas permeable material. In various embodiments, the skin 408a is coupled to the substrate such that the upper surface of the skin 408a may be flush with the top of the lip of the substrate 404. In various embodiments, the skin 408a is configured to sit below the top edge of the lip of the substrate 404, such that there is a recessed cavity formed on the upper surface of the skin 408a. In various embodiments, the skin 408a extends to cover each opening of the internal framework in order to form a seal between the skin 408a and substrate 404. In various embodiments, the skin 408a is overmolded onto the substrate 404. In various embodiments, the skin 408a is formed as a separate component (e.g., by injection molding) and affixed to the substrate 404 (e.g., via an adhesive).

In various embodiments, the skin 408a includes a protrusion 420 extending from an upper surface therefrom. In various embodiments, the protrusion 420 is similar or the same as any protrusion described herein. In various embodiments, the protrusion 420 extends perpendicular to the planar upper surface of skin 408a. In various embodiments, the protrusion 420 is formed as generally elongate shape having a first end and a second end, extending a height above the upper surface of the skin 408a. In various embodiments, the elongate protrusion 420 is disposed laterally across the upper surface of the skin 408a extending parallel to the short side of the adapter 400. In various embodiments, the protrusion 420 is angled to extend along a longitudinal axis of adapter 400. In various embodiments, the protrusion 420 is angled diagonally across the adapter 400, such as extending at least a portion of the distance between opposite corners of the adapter 400. In various embodiments, the protrusion 420 includes a distal end spaced from the upper surface of the skin 408a having a perpendicular sidewall extending therebetween. In various embodiments, the protrusion 420 includes a knob or other feature configured to facilitate grasping by forceps.

In various embodiments, the protrusion 420 is formed as a unitary component with the skin 408a. In various embodiments, the protrusion 420 is coupled to the skin 408a, such as by chemical adhesion, joinery or mechanical fasteners. In various embodiments, the protrusion 420 includes one or more openings such as a loop, allowing for forceps or a user's fingers to grasp underneath the topmost portion of the protrusion. In various embodiments, more than one protrusion 420 extends from the upper surface of the skin 408a. In various embodiments, each protrusion 420 may be identical or of varied geometry. In various embodiments, the protrusion 420 is sized in order to be grasped with forceps or a user's fingers and the adapter 400 lifted therewith.

With continued reference to the exemplary embodiment of FIG. 3F, the adapter 400 includes a second skin 408b disposed on an opposite and opposing side of the substrate 404. In various embodiments, the second skin 408b is similarly affixed to a lower surface of substrate 404. In various embodiments, skin 408b is disposed within a lower lip of the substrate 404 and overlaid on the internal framework such that the bottom surface of the skin 408b is flush with a bottom edge of the lip of the substrate 404. In various embodiments, there may be no lip disposed on the underside of the substrate 404, such that the skin 408b may be coupled to a planar bottom surface of the substrate 404 and flush with the radial edge of the adapter 400. In various embodiments, the skin 408b is formed from silicone or another gas permeable material. In various embodiments, the skin 408b is disposed over each opening of the internal framework and form a seal against the bottom surface of the substrate 404. In various embodiments, the skin 408a and the skin 408b are one unitary feature. For example, the skins 408a, 408b may be an integral material overmolded in a single step and the material permeates the struts of the substrate 404.

With continued reference to FIG. 3F, the adapter 400 includes a plurality of feet 412 extending from the lower surface of the skin 408b. In various embodiments, the plurality of feet 412 are spaced about the perimeter portion of the lower surface of the skin 408b. In various embodiments, the plurality of feet 412 are equally spaced about the perimeter portion. In various embodiments, the plurality of feet 412 have a uniform spacing between said feet 412 about the perimeter portion of the adapter. In various embodiments, the plurality of feet 412 are numbered per side of the adapter 400. For example, two feet 412 may be spaced about the long sides of the adapter 400 and a single foot 412 centrally located on each of the short sides of the adapter 400. In various embodiments, a single continuous foot circumscribes the perimeter portion of the lower surface of the skin 408b, said continuous foot or lower lip may include at least one opening therein. In various embodiments, each foot 412 of the plurality of feet includes an inner edge and an outer edge. As shown in FIG. 3F, the outer edge of each foot 412 is coplanar with the edge of the adapter 400, that is to say that the feet 412 do not extend radially further than the planform edge of the adapter 400. In various embodiments, the plurality of feet 412 include an outer edge that extend radially outward from the edge of the adapter 400, such that the feet extend both perpendicularly downward from the lower surface of the skin 408b and radially outward form the edge of the adapter 400.

Additionally, or alternatively, the feet 412 may include a rounded cross-section shape, such that the feet 412 meet the edge of adapter 400 proximate a cylindrical axis of the foot, the cylindrical sidewall of each foot extending both downward from the lower surface of the body 404 and outwardly from the perimeter of the adapter 400. In various embodiments, each foot 412 may include any suitable cross-section shape including rectilinear, circular, oblong, or more complex contoured polygons.

In various embodiments, each foot 412 of plurality of feet is configured to extend from the lower surface of the skin 408b equidistantly, thereby forming a chamber underneath the adapter 400 when the feet 412 contact a flat surface, such as a glass slide forming a bottom surface of a well of an open well flow cell. In various embodiments, each of the plurality of feet 112 may project 5 micrometers to about 2 mm. One of ordinary skill in the art would appreciate that to adjust the volume of the chamber formed underneath the adapter 400, the feet 412 may be adjusted in order to lower or raise the adapter 400 off of the platform (e.g., glass slide) on which it stands. This disclosure does not seek to limit the size and shape of the feet 412, and therefore the volume captured underneath the adapter 400. For example, and without limitation, the adapter 400 and the feet 412 may be sized to define a chamber having a volume of 10-1000 μL thereunder. Preferably, the adapter 400 and the feet 412 are sized to define a chamber having a volume of 100-500 μL. In various embodiments, when inserted into an open well flow cell, the adapter 400 and the feet 412 define a chamber having a volume of 10, 20, 30, 40, 50, 60, 70, 80, 90, or 100 μL, for example. In various embodiments, the adapter 100 is configured to reduce the overall volume of liquid required to fill the well of an open well flow cell.

With continued reference to FIG. 3F, the adapter 400 includes an inlet 416. The inlet 416 may be similar or the same as the inlets 116, 316. In various embodiments, the inlet 416 may be any opening disposed through the adapter 400 that fluidly connects the upper surface and lower surface of the skins 408a, 408b, respectively. In various embodiments, the inlet 416 is formed as a notch (e.g., a circular cutout) in the perimeter portion or lip of substrate 404. In various embodiments, the inlet 416 is formed in a corner of the adapter 400. In various embodiments, the inlet 416 is formed as a notch having a curvilinear edge. In various embodiments, the curvilinear edge of the inlet is formed at a right angle to the perimeter portion of substrate 404. In various embodiments, the curvilinear edge of the inlet 416 is formed at a corner of the adapter 400, and the raised lip of the perimeter portion running along the curvilinear edge. In various embodiments, the lip is cut off at the notch of the inlet 416 (i.e., there is no lip around the notch), or extend around said notch or opening, in various embodiments. In various embodiments, the inlet 416 is sized to receive a tip of a pipette. In various embodiments, the inlet 416 is configured to provide access to the lower surface of the adapter 400 from a position above the upper surface of adapter 400, allowing for dispensing of liquid to the underside of the adapter 400 by a user handling a pipette.

In various embodiments, the inlet 416 is disposed along the perimeter portion of adapter 400. In various embodiments, the inlet 416 is disposed along a linear edge of the perimeter portion. In various embodiments, the inlet 416 is formed as a notch (e.g., circular cutout) in perimeter portion, with the curvilinear edge of the inlet cut out of a substantially linear side of the adapter 400. In various embodiments, the inlet 416 includes one or more chamfers, fillets or other edge features configured to direct liquid underneath the adapter 400. For example, and without limitation, the inlet 416 is configured with a plurality of small channels formed (e.g., machined) therein, the plurality of channels configured to evenly disperse the liquid from the inlet evenly along the lower surface of the adapter 400.

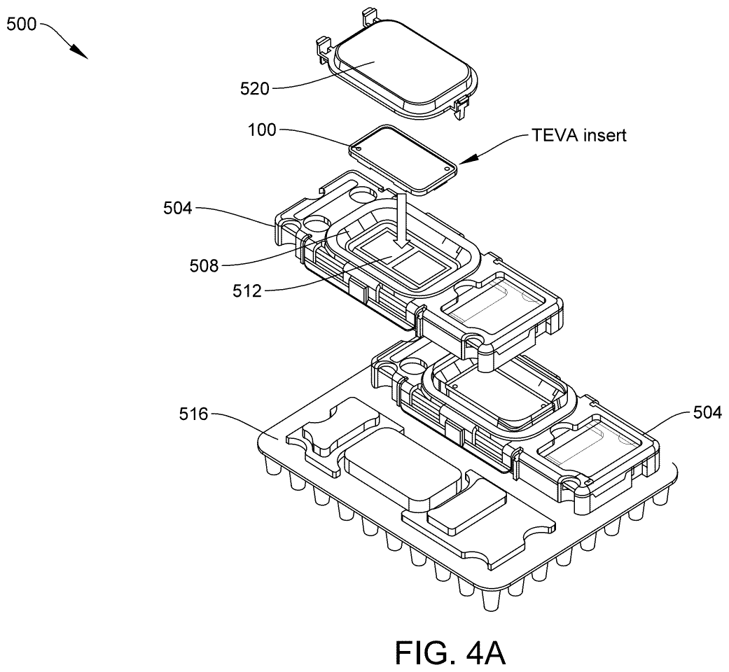

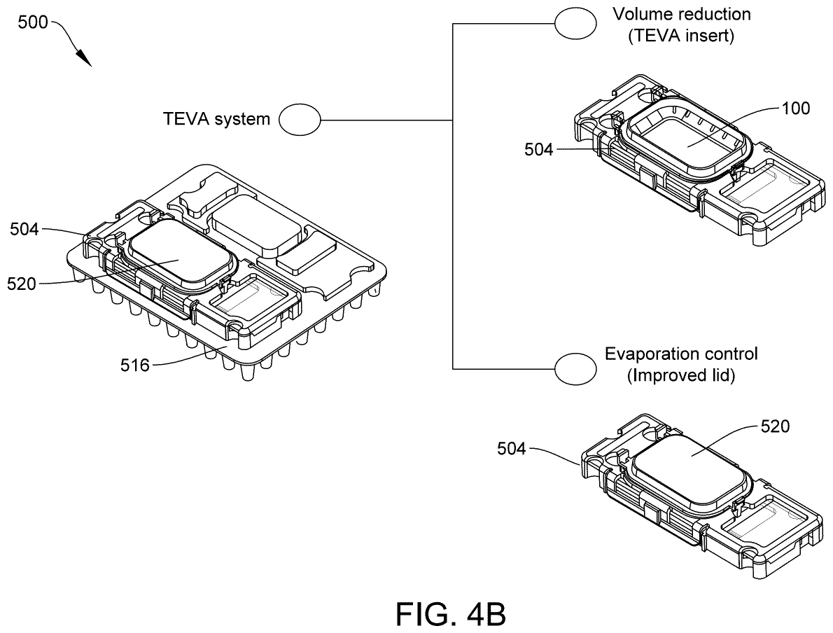

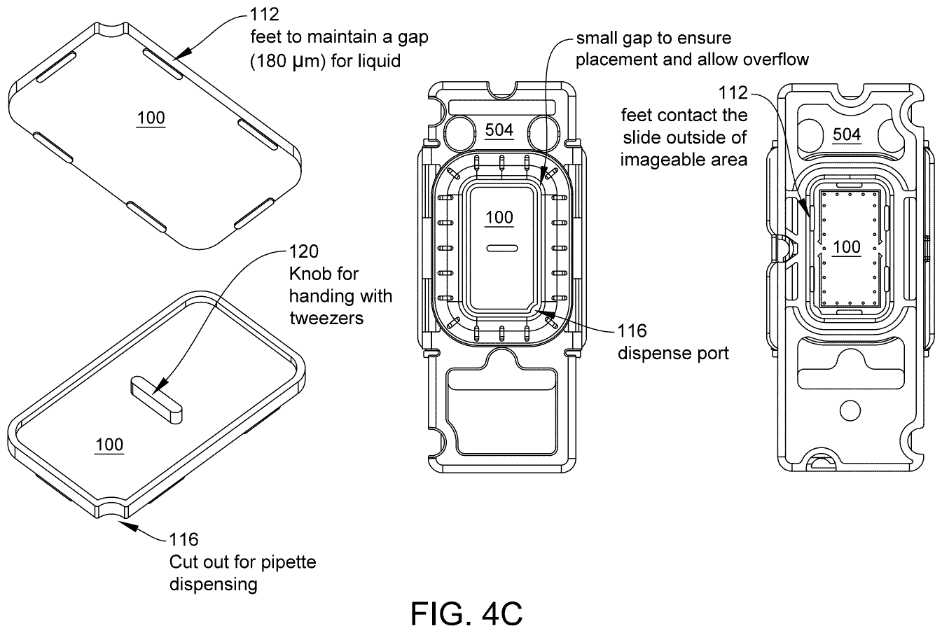

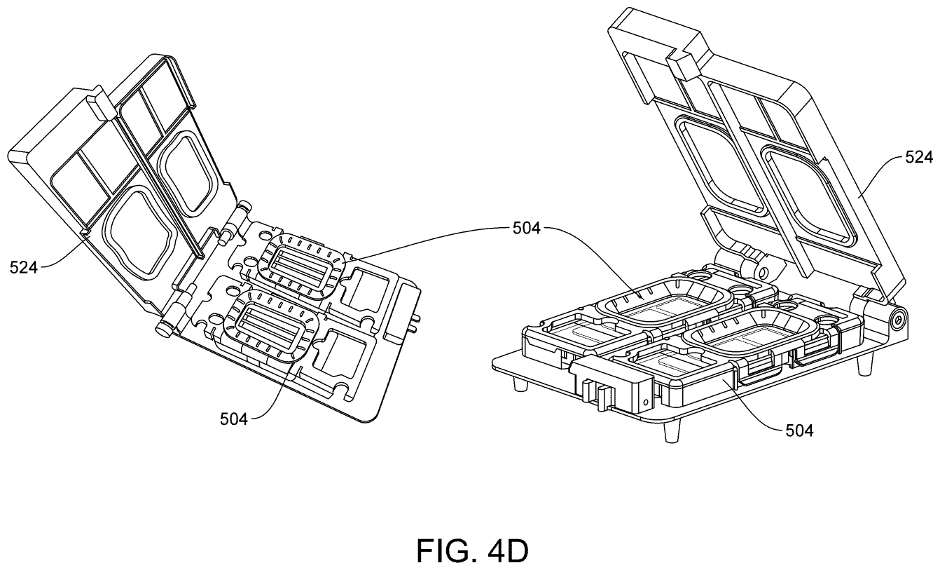

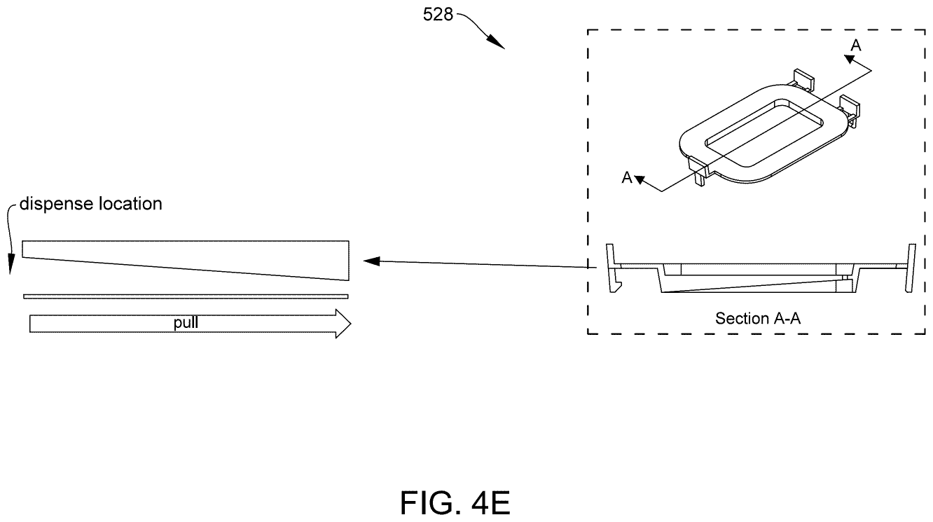

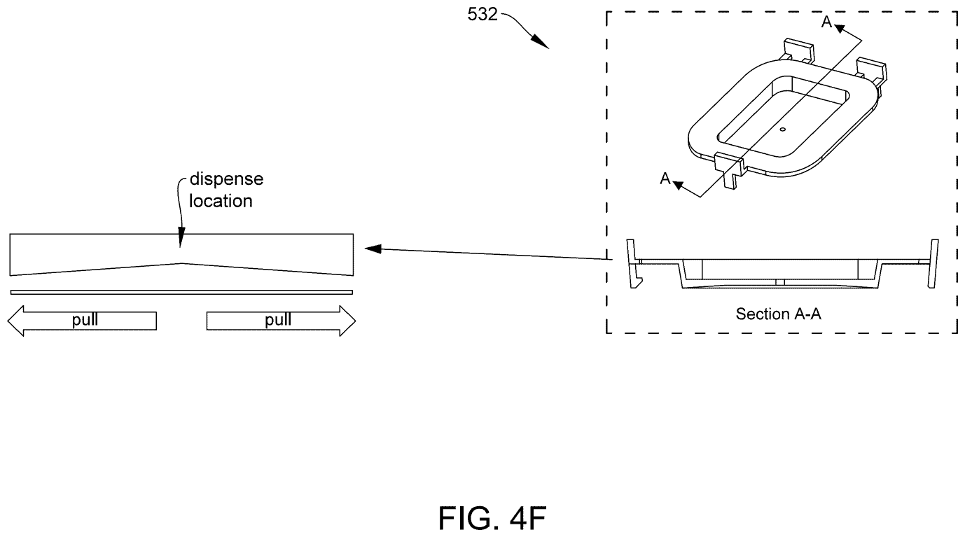

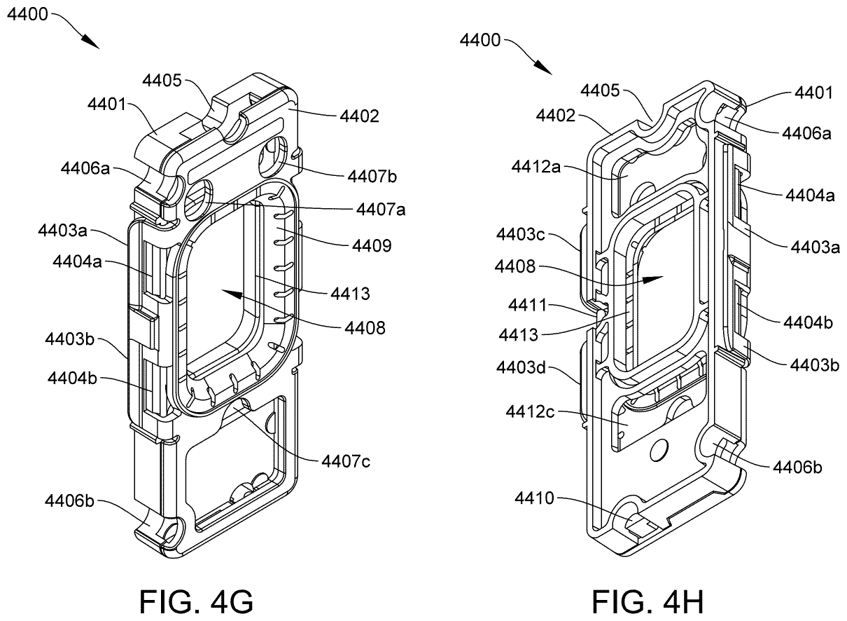

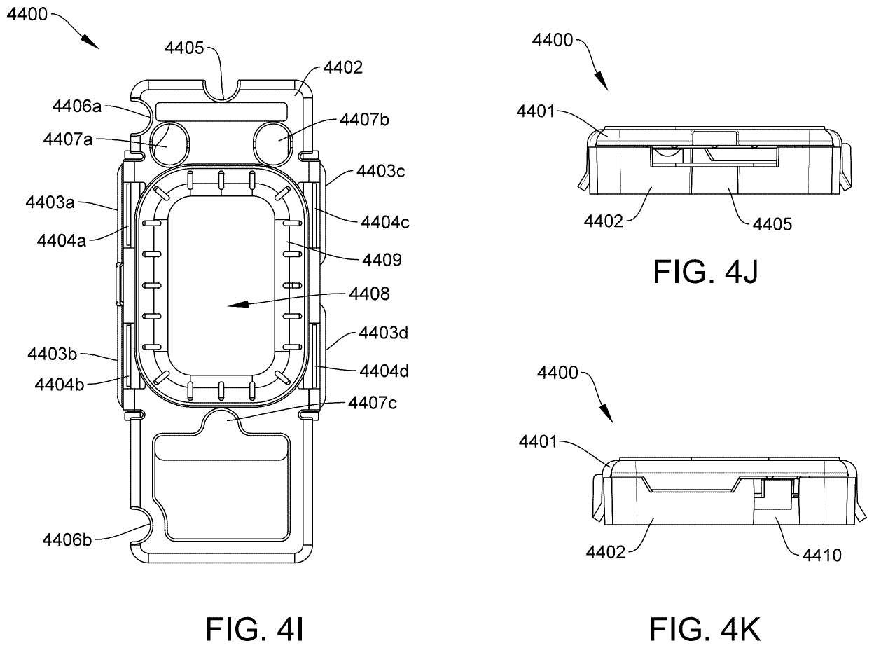

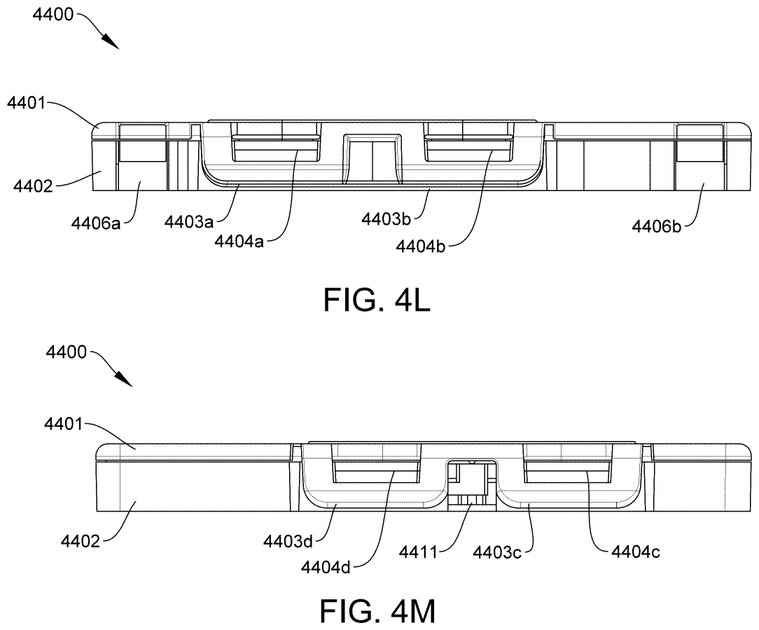

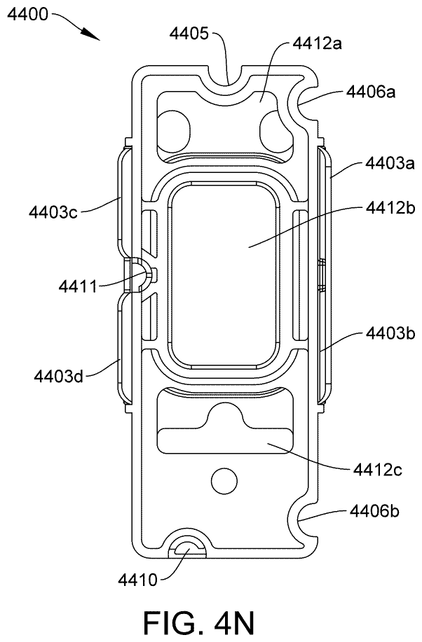

Referring now to FIGS. 4A-4B, an exemplary flow cell 500 is shown in exploded and perspective views. In various embodiments, the flow cell 500 is used in one or more imaging devices, such as an optofluidic instrument configured to image analytes (e.g., RNA, DNA, proteins, etc.) in a biological sample. In various embodiments, the flow cell 500 is configured to receive one or more optical objectives in order to image the biological sample disposed in a well 508 of an open well flow cell 500. In various embodiments, a cassette 504 is formed from one or more plastic mold shells, such as an upper shell and a lower shell configured to be coupled around a glass slide containing a biological sample disposed thereon. In various embodiments, the upper shell and the lower shell are configured to snap together via one or more hooks, latches and/or complementary bosses.

For example, and without limitation, upper shell of cassette 504 includes one more resilient members having a compliant latch configured to pass over a boss in a first direction and snap over said boss and retain the upper shell on the lower shell, arresting motion in a second direction. In various embodiments, the upper shell and the lower shell are formed as a unitary body and configured to receive a glass slide slidingly therein. In various embodiments, the cassette is configured to receive a substrate (e.g., a standard glass slide or a custom glass slide). In various embodiments, the cassette 504 includes one or more geometrical features configured to seat within a stand or base, such as base 516. In various embodiments, the base 516 includes one or more retaining features configured to mate with one or more complementary features of the lower shell of the cassette 504 in order to restrain movement of the cassette 504 on the base 516. In various embodiments, the base 516 is configured to secure the cassette 504 for further operation, such as loading into a thermocycler. In various embodiments, various shims are included between the cassette 504 and base 516 in order to reduce or prevent deformation of the cassette 504 under pressure from the thermocycler, which may be configured to press downward on the lid 520 or cassette 504. In various embodiments, the base 516 includes one or more raised portions (e.g., three raised portions) configured to support the substrate and/or improve thermal conduction between the open well flow cell and a temperature control unit, such as a thermoelectric controller or a thermocycler.

With continued reference to FIG. 4A, the flow cell 500 includes a well 508 formed in cassette 504. In various embodiments, the well 508 is configured to receive a portion of an imaging objective. In various embodiments, the well 508 is configured to circumscribe a portion of the glass slide 512 disposed therein, the glass slide 512 forming a floor of said well and configured to receive the biological sample to be imaged. In various embodiments, the well 508 circumscribes the imaging area of the glass slide 512 with a trench or other space between the bottom edge of the well 508 and the imaging area. In various embodiments, the well 508 is formed with a gasket circumscribing the generally rectilinear recess. In various embodiments, the gasket is formed with a downward slope, such that the gasket meets the floor of the well 508 with a lesser perimeter than the top edge of gasket 508, generally planar with the top of the cassette 504. In various embodiments, the gasket of 508 is configured to form a seal between the well 508 and at least one of the lid 520 or another sealing means, such as polymerase chain reaction (PCR) tape. As shown in FIG. 6B, PCR tape may be used to seal the well 508 for one or more preparatory steps, such as incubation and thermocycling. In various embodiments, well 508 is formed with a complementary planform shape with adapter 100, 300 or the like. For example, and without limitation, the well 508 may be formed as a generally rectangular cavity in the cassette 504 having rounded corners of a similar radius as any adapter described herein. In various embodiments, the gasket of well 508 is configured to form a seal against the glass slide 512 which retains a liquid within well 508 and prevent leakage onto the non-imaging areas of the glass slide 512 exterior to the well 508. In various embodiments, the well 508 is configured to receive any adapter as described herein, such as adapter 100, 300, 400. For example, and without limitation, the well 508 is configured to receive a liquid, such as a reagent before or after insertion of the adapter. In various embodiments, the adapter is configured to reduce the volume of liquid required to cover the imaging area of glass slide 512 within well 508. For example, and without limitation, the adapter is placed within the well 508, formed a cavity thereunder (shown in FIGS. 5A-5B), the adapter reduces the total amount of liquid required to cover the glass slide 512 imaging area to approximately 100 uL. For example, and without limitation, the adapter is utilized in one or more incubation periods of reagent in the well 508, as well as during thermocycling.

With continued reference to FIGS. 4A-4B, the flow cell 500 includes lid 520. In various embodiments, the lid 520 is configured to snap over said well 508 and form a seal against the gasket thereof. In various embodiments, the lid 520 is configured to couple to cassette 504, such as through resilient latches configured to snap over a geometric feature or boss of cassette 504. In various embodiments, the lid 520 is configured to couple to the cassette 504 over well 508 while adapter 100, 300, 400 is inserted therein. In various embodiments, the lid 520 is configured to hingedly couple to cassette 504. In various embodiments, the lid 520 is coupled to cassette 504 via one or more mechanical fasteners. In various embodiments, the lid 520 is formed as a unitary component with cassette 504, such as via a living hinge or other integral feature.

Referring now to FIG. 4C, the cassette 504 is shown in planform views having an adapter as described herein inserted. Specifically in FIG. 4C, adapter 100 is shown with feet 112 contacting the glass slide 512 within well 508. In various embodiments, feet 112 are configured to contact the glass slide 512 outside the imaging area of said slide. In various embodiments, the feet 112 are configured to contact the floor of well 508 adjacent to the bottom edge of the well 508, formed by the gasket contacting the substrate. As shown in FIG. 4C, a gap is formed between the perimeter portion of the adapter and the edge of well 508. This gap may be configured to receive a reagent or other liquid overflow dispersed radially outward from underneath the adapter 100.

Referring now to FIG. 4D, a cassette 504 is shown within a sealable housing 524. In various embodiments, sealable housing 524 is hingedly coupled to base 516 or another base configured to secure said cassette 504 thereon. In various embodiments, the sealable housing 524 includes a gasket disposed on the underside of the rotatable cover configured to form a seal with the well 508. In various embodiments, the sealable housing 524 is configured to retain more than one (e.g., two) cassettes 504 side-by-side therein. In various embodiments, the sealable housing 524 is configured to be selectively latched closed by or one or more resilient members configured to snap with a receptable on the base.

Referring now to FIGS. 4E-4F, an adapter lid 528 is shown in perspective views. In various embodiments, adapter lid 528 is configured to couple to the upper shell of cassette 504 similarly to the lid 520, having a resilient member configured to snap on a portion of the cassette 504. In various embodiments, adapter lid 528 is configured to form a seal against the gasket of well 508 and fully cover the well 508 to prevent evaporation of the liquid or reagent therein, thus preserving the amount of liquid.

In various embodiments, adapter lid 528 has a planar or recessed upper surface. In various embodiments, adapter lid 528 has an opening formed therein, and said opening is configured to receive a pipette or liquid dispensed by other means and convey said liquid to the well 508. In various embodiments, the adapter lid 528 includes a non-planar lower surface. In various embodiments, the lower surface of the adapter lid 528 is configured to sit within the well 508 and form a cavity therebetween, and the cavity configured to receive the liquid or reagent therein. In various embodiments, the lower surface of adapter lid 528 is spaced above the floor of the well 508. For example, as shown in FIG. 4E, the lower surface of the adapter lid 528 may extend lower towards the floor of the well 508 proximate a first side of the well than a second side of the well, that is to say that the thickness of the adapter lid 528 may be greater proximate the first side of the well than the second, thus forming a sloped bottom surface of the adapter lid 508. In various embodiments, adapter lid 528 is configured to receive the liquid or reagent proximate the higher side of the lower surface, such that liquid is directed towards the shallower side of the well via capillary action.

In various embodiments, the lower surface of the adapter lid 528 is disposed on either longitudinal or lateral sides of the well. In various embodiments, adapter lid 528 has any suitable lower surface geometry, wherein any portion other well 508 may be shallower than another portion, thus the direction of capillary action. In various embodiments, the adapter lid 528 is utilized in the flow cell 500 instead of adapter 100 and lid 520. That is to say, the functions of the lid 520 and adapter 100 may be performed by adapter lid 528, both sealing the well 508 against evaporation and reducing the total volume of liquid to contact the sample in the well 508. In various embodiments, adapter lid 528 is configured to be inserted in flow cell 500 in tandem with an adapter 100, 300, 400 and lid 520.

Referring to FIG. 4F, an adapter lid 532 is shown in perspective and section views. In various embodiments, the adapter lid 532 includes a non-planar lower surface. In various embodiments, the lower surface of adapter lid 532 is vaulted proximate a central portion of the adapter lid, sloping downward to edge portions that extend lower from the adapter lid than said vaulted portion. In various embodiments, the adapter lid 532 includes an inlet disposed in a central portion thereof. In various embodiments, the inlet is formed as an opening from the upper surface of the adapter lid to the lower surface of the adapter lid proximate the vaulted portion, such that liquid exiting the inlet will be directed to the edge portions via capillary action. In various embodiments, more than one vault is formed in the adapter lid 532 lower surface (e.g., the lower surface has an inverted polygonal pyramid shape). In various embodiments, the vaulted portion slopes downward toward two or more edges of the adapter lid, that is to say, the vault slopes downward toward four edges of the adapter lid, such as to form a tented internal cavity. In various embodiments, the vault of the adapter lid 532 includes a linear ridge where the planar sloped portions come into contact. In various embodiments, the vault of adapter lid 532 is gradual, forming a bullnose or dome shape.

FIGS. 4G-4N illustrate a sample device 4400. The sample device 4400 may be the same or similar to any cassette herein, as well as any described in U.S. patent application Ser. No. 18/328,200, filed on, Jun. 2, 2023 the entire contents of which are hereby incorporated by reference in their entirety. In various embodiments, the sample device 4400 is a cassette. In various embodiments, the sample device 4400 includes a bottom portion 4401 and a top portion 4402. In various embodiments, the top portion 4402 has one or more snap joints 4403a-4403d (e.g., a cantilevered snap joint) configured to couple to lugs 4404a-4404d (cantilevered lugs) of the bottom portion 4401. In various embodiments, the bottom portion 4402 may have the snap joints while the top portion has the lugs. In various embodiments, the sample device 4400 includes a recess 4405 configured to receive a Y pin of a sample interface module. In various embodiments, the sample device 4400 includes recesses 4406a-4406b configured to receive X pins of a SIM. In various embodiments, the sample device 4400 includes apertures 4407a-4407c configured to receive Z pins on a lid. The Z pins may be configured to contact a substrate (e.g., a glass slide) positioned within (e.g., sandwiched between) the bottom portion 4401 and the top portion 4402 in the gap 4413. When the substrate (not shown) is positioned within the sample device 4400, a well 4408 is formed between the substrate and the gasket (not shown). In various embodiments, the sample device 4400 includes a recess 4410 configured to receive a Y cam. In various embodiments, the sample device 4400 includes a recess 4411 configured to receive the X cam. In various embodiments, the recesses 4410, 4411 may include a soft material (e.g., silicone insert, rubber insert, etc.) to prevent concentrated point forces from the cams that may damage the sample device 4400. Along a periphery of the well 4408, the top portion 4402 includes ridges 4409 configured to secure a gasket (not shown) therein to thereby form a seal between the substrate and the top portion 4402 of the sample device 4400.

In various embodiments, the sample device 4400 includes apertures 4412a-4412c configured to receive the raised portions of a sample positioning plate. As illustrated, for example, apertures 4412a and 4412c can be on either side of aperture 4412b. In various embodiments, the shape of the perimeters of the apertures 4412a-4412c are complementary to the shape of the perimeters of the respective raised portions. In various embodiments, the apertures 4412a-4412c are slightly larger than the raised portions to allow for receiving of the raised portions.

Referring to FIG. 7, a method 700 for using a flow cell is shown in flow chart form. At step 705, an open well flow cell is provided having a sample disposed on a substrate. The open well flow cell may include, as described herein, a cassette formed by an upper casing, a lower casing, and a gasket. The upper casing may be the same or similar to any upper casing as described herein, for example the upper shell or cassette 504 or sample device 4400. The upper casing may be releasably coupled to the lower casing, wherein a gap is formed between the upper casing and the lower casing when the upper casing is coupled to the lower casing. The lower casing may be the same or similar to any lower casing as described herein. The open well flow cell may include a sample substrate disposed in the gap. The sample substrate may be a glass slide such as glass slide 512. An opening may be formed in the upper casing, the open circumscribed by the gasket, wherein the gasket and the sample substrate, in combination, at least partially define an open well. The gasket may be sloped as described herein, such that a top portion of the gasket is wider than a lower portion, thereby forming a sloped gasket circumscribing the well.

At step 710, an adapter is positioned in the open well to thereby form a reversible flow cell. In various embodiments, the adapter positioned in the open well may be any adapter as described herein, such as adapter 100, adapter 300 and adapter 400. The adapter may be positioned in the open well as described herein, wherein the at least one foot of the adapter contacts the top surface of the sample substrate (e.g., glass slide) and the adapter is spaced from the substrate to form a volume thereunder. The adapter is positioned in the open well and thereby forms a reversible flow cell that reduces the volume of reagents required to fully contact (e.g., submerge) the sample and perform one or more reactions with the sample (e.g., flowing a solution of fluorescently tagged nucleotides or fluorescently tagged oligonucleotides to thereby tag one or more analytes in a sample, such as a biological sample or a hydrogel).

At step 715, at least one reagent is flowed (e.g., dispensed from a pipette) into the inlet thereby contacting the sample with the at least one reagent. The adapter positioned in the well (forming the reversible flow cell) may reduce the overall volume of the reagent, wherein the substrate, the gasket, and the adapter form the boundaries of the volume of the flow cell. The adapter forms the upper boundary of the reversible flow cell and that the walls of the cassette and the top surface of the sample substrate (e.g., a glass slide) form the sides and bottom of the reversible flow cell, respectively.

The flow devices of the disclosure may include any suitable material, for example, polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

In some embodiments, the present devices may be assembled by alignment and stacking of the slide, tissue sample, fluidic interface layer, gasket, and adaptor. For example, the adaptor may be aligned with and placed onto the fluidic interface layer, or the adapter can be placed on the slide prior to dispensing the fluidic interface layer of reagent(s). Compression may be applied during assembly such that the fluidic interface layer, gasket, and/or substrate layer are reversibly attached. Assembly, and disassembly, can be performed manually.

### Surface Properties

A surface of the device may include a material, coating, or surface texture that determines the physical properties of the device. In particular, the flow of liquids may be controlled by the surface properties (e.g., wettability of a liquid-contacting surface). In some cases, a portion (e.g., a flow path) may have a surface having a wettability suitable for facilitating liquid flow (e.g., in a flow path).

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method.

For example, portions of the device carrying aqueous phases (e.g., a channel or flow path) may have a surface material or coating that is hydrophilic or more hydrophilic than the other parts of the device, e.g., include a material or coating having a water contact angle of less than or equal to about 90°, and/or other components of the device may have a surface material or coating that is hydrophobic or more hydrophobic than the flow path, e.g., include a material or coating having a water contact angle of greater than 70° (e.g., greater than 90°, greater than 95°, greater than 100° (e.g., 95°-120° or)) 100°-10°. The system can be designed to have a single type of material or coating throughout. Surface textures may also be employed to control fluid flow.

The surface properties may be those of a native surface (i.e., the surface properties of the bulk material used for fabrication) or of a surface treatment. Non-limiting examples of surface treatments include, e.g., surface coatings and surface textures. In one approach, the surface properties are attributable to one or more surface coatings present in a portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the system. Example metal oxides useful for coating surfaces include, but are not limited to, Al2O3, TiO2, SiO2, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al2O3 can be deposited on a surface by contacting it with trimethylaluminum (TMA) and water.

In another approach, the surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO2/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoro-ethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about) 150°.

The difference in water contact angles between that of a hydrophilic or more hydrophilic material or coating and a hydrophobic or more hydrophobic material or coating may be 5° to 100°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, or 100°.

Surfaces may also be coated with various functional materials, e.g., metals or other electrically or magnetically conducting materials. For example, a surface may include a metal coating for electrical connectivity, detection, or resistive heating. Alternatively, such elements may be physically incorporated into a device or placed in physical contact with a device.

Surface properties may also be modified after application. Such methods include exposure to UV, ozone, plasma (e.g., oxygen, argon, etc.), UV photografting and UV induced photo-catalytic oxidation. These and other methods can alter the properties of the surface (e.g., wettability such as hydrophilicity, fluorophilicity, or hydrophobicity) or add an additional layer (e.g., biomolecules) to the surface.

The above discussion centers on the water contact angle. It will be understood that liquids employed may not be water, or even aqueous. Accordingly, the actual contact angle of a liquid on a surface may differ from the water contact angle. Furthermore, the determination of a water contact angle of a material or coating can be made on that material or coating when not incorporated into a device.

### Methods of Detection

In some embodiments, the methods described herein include detecting, e.g., tissue, cells, particulate components thereof, or other analytes. A sensor (e.g., optical, electrical, magnetic, impedance, or fluorescent sensor) in the detector may sense a particular feature (e.g., fluorescence, charge) or characteristic (e.g., diameter or volume) of sample (e.g., a cell or group of cells in a tissue sample).

Methods of detection include optical detection, e.g., by visual observation, e.g., using an optical bright-field. In some embodiments, analytes thereof are detectable by light absorbance, scatter, emission, and/or transmission. Additionally, or alternatively, optical detection can include fluorescent detection, e.g., by fluorescent microscopy. In still further embodiments, methods of the disclosure include detection of analytes having electrical or magnetic labels or properties. In some embodiments, the device includes a plurality (e.g., 2, 3, 4, 5, 6, 7, 8, 9, 10, or more) of detectors. Detectors may or may not be integrated with the device. In some embodiments, the substrate layer and/or fluid interface layer may be transparent, or include transparent portions, e.g., to allow for visualization, imaging, or detection. Substrate layers or fluidic interface layers, or portions thereof, may include transparent materials such as glass, quartz, polystyrene, polyethylene terephthalate, etc. The detection methods described herein may be automated, e.g., including robotic systems.

A variety of analytes, e.g., tissue, cell, or particulate component or macromolecular constituent thereof, characteristics can be observed and/or quantified. For example, characteristics such as analyte, e.g., cell, or particulate component or macromolecular constituent thereof, size (e.g., diameter) and shape can be readily observed visually and recorded by image or video acquisition software known in the art. In addition, the number of analytes, e.g., cell or particulate component thereof, can similarly be observed visually, by using detectable labels, or by other optical characteristics (e.g., scatter, absorbance, transmission, emission, such as fluorescence, etc.). In some embodiments, methods of the disclosure include observing the presence and/or intensity of a fluorescently or ionically tagged antigen-binding molecule bound to a biological antigen (e.g., a protein or nucleic acid, e.g., associated with an intact cell).

### Preparation of Samples

A variety of steps can be performed to prepare a biological tissue sample for analysis. In some embodiments, a sample is collected or deposited in the device described herein and prepared using a device described herein. In some embodiments, a prepared sample is placed on a substrate layer described herein. Except where indicated otherwise, the preparative steps described below can generally be combined in any manner to appropriately prepare a particular sample for analysis. In some aspects, any of the preparative or processing steps described can be performed on a sample using a device described herein, e.g., to deliver reagents via a fluid source. For example, the preparing or processing may include but is not limited to steps for fixing, embedding, staining, crosslinking, permeabilizing the sample, providing and/or removing reagents (e.g., probes, enzymes, buffers, etc.) or any combinations thereof.

A biological tissue sample can be harvested from a subject (e.g., via surgical biopsy, whole subject sectioning), grown in vitro on a growth substrate or culture dish as a population of cells, or prepared as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., from about 10 μm to about 20 μm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 μm. Thicker sections can also be used if desired or convenient, e.g., at least 70, 80, 90, or 100 μm or more. Typically, the thickness of a tissue section is about 1-100 μm, 1-50 μm, 1-30 μm, 1-25 μm, 1-20 μm, 1-15 μm, 1-10 μm, 2-8 μm, 3-7 μm, or 4-6 μm, but as mentioned above, sections with thicknesses larger or smaller than these ranges can also be analyzed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analyzed successively to obtain three-dimensional information about the biological sample.

In some embodiments, the biological tissue sample (e.g., a tissue section as described above) can be prepared by deep freezing at a temperature suitable to maintain or preserve the integrity (e.g., the physical characteristics) of the tissue structure. Such a temperature can be, e.g., less than −20° C., or less than −25° C., −30° C., −40° C., −50° C., −60° C., −70° C., 80° C.- 90° C., −100° C., −110° C., −120° C., −130° C., −140° C., −150° C., −160° C., −170° C., −180° C., −190° C., or −200° C. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than −15° C., less than −20° C., or less than −25° C. A sample can be snap frozen in isopentane and liquid nitrogen. Frozen samples can be stored in a sealed container prior to embedding.

### Fixation and Postfixation

In some embodiments, the biological sample can be prepared using formalin-fixation and paraffin-embedding (FFPE), which are established methods. In some embodiments, cell suspensions and other non-tissue samples can be prepared using formalin-fixation and paraffin-embedding. Following fixation of the sample and embedding in a paraffin or resin block, the sample can be sectioned as described above. Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a biological sample can be fixed in any of a variety of other fixatives to preserve the biological structure of the sample prior to analysis. For example, a sample can be fixed via immersion in ethanol, methanol, acetone, paraformaldehyde (PFA)-Triton, and combinations thereof.

In some embodiments, acetone fixation is used with fresh frozen samples, which can include, but are not limited to, cortex tissue, mouse olfactory bulb, human brain tumor, human post-mortem brain, and breast cancer samples. When acetone fixation is performed, pre-permeabilization steps (described below) may not be performed. Alternatively, acetone fixation can be performed in conjunction with permeabilization steps.

In some embodiments, the methods provided herein includes one or more post-fixing (also referred to as postfixation) steps. In some embodiments, one or more post-fixing step is performed after contacting a sample with a polynucleotide disclosed herein, e.g., one or more probes such as a circular or padlock probe. In some embodiments, one or more post-fixing step is performed after a hybridization complex including a probe and a target is formed in a sample. In some embodiments, one or more post-fixing step is performed prior to a ligation reaction disclosed herein, such as the ligation to circularize a padlock probe.

In some embodiments, one or more post-fixing step is performed after contacting a sample with a binding or labelling agent (e.g., an antibody or antigen binding fragment thereof) for a non-nucleic acid analyte such as a protein analyte. The labelling agent can include a nucleic acid molecule (e.g., reporter oligonucleotide) including a sequence corresponding to the labelling agent and therefore corresponds to (e.g., uniquely identifies) the analyte. In some embodiments, the labelling agent can include a reporter oligonucleotide including one or more barcode sequences.

A post-fixing step may be performed using any suitable fixation reagent disclosed herein, for example, 3% (w/v) paraformaldehyde in DEPC-PBS.

### Embedding

As an alternative to paraffin embedding described above, a biological sample can be embedded in any of a variety of other embedding materials to provide structural substrate to the sample prior to sectioning and other handling steps. In some cases, the embedding material can be removed e.g., prior to analysis of tissue sections obtained from the sample. Suitable embedding materials include, but are not limited to, waxes, resins (e.g., methacrylate resins), epoxies, and agar.

In some embodiments, the biological sample can be embedded in a matrix (e.g., a hydrogel matrix). Embedding the sample in this manner typically involves contacting the biological sample with a hydrogel such that the biological sample becomes surrounded by the hydrogel. For example, the sample can be embedded by contacting the sample with a suitable polymer material, and activating the polymer material to form a hydrogel. In some embodiments, the hydrogel is formed such that the hydrogel is internalized within the biological sample.

In some embodiments, the biological sample is immobilized in the hydrogel via cross-linking of the polymer material that forms the hydrogel. Cross-linking can be performed chemically and/or photochemically, or alternatively by any other hydrogel-formation method known in the art.

The composition and application of the hydrogel-matrix to a biological sample typically depends on the nature and preparation of the biological sample (e.g., sectioned, non-sectioned, type of fixation). As one example, where the biological sample is a tissue section, the hydrogel-matrix can include a monomer solution and an ammonium persulfate (APS) initiator/tetramethylethylenediamine (TEMED) accelerator solution. As another example, where the biological sample consists of cells (e.g., cultured cells or cells disassociated from a tissue sample), the cells can be incubated with the monomer solution and APS/TEMED solutions. For cells, hydrogel-matrix gels are formed in compartments, including but not limited to devices used to culture, maintain, or transport the cells. For example, hydrogel-matrices can be formed with monomer solution plus APS/TEMED added to the compartment to a depth ranging from about 0.1 μm to about 2 mm.

Additional methods and aspects of hydrogel embedding of biological samples are described for example in Chen et al., Science 347 (6221): 543-548, 2015, the entire contents of which are incorporated herein by reference.

### Staining and Immunohistochemistry (INC)

To facilitate visualization, biological samples can be stained using a wide variety of stains and staining techniques. In some embodiments, for example, a sample can be stained using any number of stains and/or immunohistochemical reagents. One or more staining steps may be performed to prepare or process a biological sample for an assay described herein or may be performed during and/or after an assay. In some instances, the provided methods and devices for the reversible assembly and use of a flowcell allow access to the sample after performing fluidic operations. In some cases, the provided flowcell can be sealed then access can be gained to the sample without disrupting the sample (e.g., to perform staining or IHC after performing other fluidic steps of an assay). In some embodiments, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some embodiments, cells in the sample can be segmented using one or more images taken of the stained sample.

In some embodiments, the stain is performed using a lipophilic dye. In some examples, the staining is performed with a lipophilic carbocyanine or aminostyryl dye, or analogs thereof (e.g., Dil, DiO, DiR, DiD). Other cell membrane stains may include FM and RH dyes or immunohistochemical reagents specific for cell membrane proteins. In some examples, the stain may include but is not limited to, acridine orange, acid fuchsin, Bismarck brown, carmine, coomassie blue, cresyl violet, DAPI, eosin, ethidium bromide, acid fuchsine, haematoxylin, Hoechst stains, iodine, methyl green, methylene blue, neutral red, Nile blue, Nile red, osmium tetroxide, ruthenium red, propidium iodide, rhodamine (e.g., rhodamine B), or safranine, or derivatives thereof. In some embodiments, the sample may be stained with haematoxylin and eosin (H&E).

In some embodiments, biological samples can be destained. Methods of destaining or discoloring a biological sample are known in the art, and generally depend on the nature of the stain(s) applied to the sample. For example, in some embodiments, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65 (8): 431-444, Lin et al., Nat Commun. 2015; 6: 8390, Pirici et al., J. Histochem. Cytochem. 2009; 57: 567-75, and Glass et al., J. Histochem. Cytochem. 2009; 57: 899-905, the entire contents of each of which are incorporated herein by reference.

### Isometric Expansion

In some embodiments, a biological sample embedded in a matrix (e.g., a hydrogel) can be isometrically expanded. Isometric expansion methods that can be used include hydration, a preparative step in expansion microscopy, as described in Chen et al., Science 347 (6221): 543-548, 2015.

Isometric expansion can be performed by anchoring one or more components of a biological sample (e.g., nucleic acids, proteins) to a gel, followed by gel formation, proteolysis, and swelling. In some embodiments, analytes in the sample, products of the analytes, and/or probes associated with analytes in the sample can be anchored to the matrix (e.g., hydrogel). Isometric expansion of the biological sample can occur prior to immobilization of the biological sample on a substrate, or after the biological sample is immobilized to a substrate. In some embodiments, the isometrically expanded biological sample can be removed from the substrate prior to contacting the substrate with probes disclosed herein.

Isometric expansion of the sample can increase the spatial resolution of the subsequent analysis of the sample. The increased resolution in spatial profiling can be determined by comparison of an isometrically expanded sample with a sample that has not been isometrically expanded.

In some embodiments, a biological sample is isometrically expanded to a size at least 2×, 2.1×, 2.2×, 2.3×, 2.4×, 2.5×, 2.6×, 2.7×, 2.8×, 2.9×, 3×, 3.1×, 3.2×, 3.3×, 3.4×, 3.5×, 3.6×, 3.7×, 3.8×, 3.9×, 4×, 4.1×, 4.2×, 4.3×, 4.4×, 4.5×, 4.6×, 4.7×, 4.8×, or 4.9× its non-expanded size. In some embodiments, the sample is isometrically expanded to at least 2× and less than 20× of its non-expanded size.

### Crosslinking and De-Crosslinking

In some embodiments, the biological sample is reversibly cross-linked. In some aspects, the analytes, polynucleotides and/or product of an analyte or a probe bound thereto can be anchored to a polymer matrix. For example, the polymer matrix can be a hydrogel. In some embodiments, portions of the sample can be modified to contain functional groups that can be used as an anchoring site to attach the polynucleotide probes and/or amplification product to a polymer matrix. In some embodiments, a modified probe including oligo dT may be used to bind to mRNA molecules of interest, followed by reversible crosslinking of the mRNA molecules.

In some embodiments, a hydrogel can include hydrogel subunits, such as, but not limited to, acrylamide, bis-acrylamide, polyacrylamide and derivatives thereof, poly(ethylene glycol) and derivatives thereof (e.g. PEG-acrylate (PEG-DA), PEG-RGD), gelatin-methacryloyl (GeIMA), methacrylated hyaluronic acid (MeHA), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose, and the like, and combinations thereof.

In some embodiments, a hydrogel includes a hybrid material, e.g., the hydrogel material includes elements of both synthetic and natural polymers. Examples of suitable hydrogels are described, for example, in U.S. Pat. Nos. 6,391,937, 9,512,422, and 9,889,422, and in U.S. Patent Application Publication Nos. 2017/0253918, 2018/0052081 and 2010/0055733, the entire contents of each of which are incorporated herein by reference.

In some embodiments, the hydrogel can form the substrate. In some embodiments, the substrate includes a hydrogel and one or more second materials. In some embodiments, the hydrogel is placed on top of one or more second materials. For example, the hydrogel can be pre-formed and then placed on top of, underneath, or in any other configuration with one or more second materials. In some embodiments, hydrogel formation occurs after contacting one or more second materials during formation of the substrate. Hydrogel formation can also occur within a structure (e.g., wells, ridges, projections, and/or markings) located on a substrate.

In some embodiments, hydrogel formation on a substrate occurs before, contemporaneously with, or after the sample is in the device. For example, hydrogel formation can be performed on the sample on the substrate layer.

In some embodiments, hydrogel formation occurs within a biological sample. In some embodiments, a biological sample (e.g., tissue section) is embedded in a hydrogel. In some embodiments, hydrogel subunits are infused into the biological sample, and polymerization of the hydrogel is initiated by an external or internal stimulus.

In embodiments in which a hydrogel is formed within a biological sample, functionalization chemistry can be used. In some embodiments, functionalization chemistry includes hydrogel-tissue chemistry (HTC). Any hydrogel-tissue backbone (e.g., synthetic or native) suitable for HTC can be used for anchoring biological macromolecules and modulating functionalization. Non-limiting examples of methods using HTC backbone variants include CLARITY, PACT, ExM, SWITCH and ePACT. In some embodiments, hydrogel formation within a biological sample is permanent. For example, biological macromolecules can permanently adhere to the hydrogel allowing multiple rounds of interrogation. In some embodiments, hydrogel formation within a biological sample is reversible.

In some embodiments, a method disclosed herein includes de-crosslinking the reversibly cross-linked biological sample. The de-crosslinking does not need to be complete. In some embodiments, only a portion of crosslinked molecules in the reversibly cross-linked biological sample are de-crosslinked and allowed to migrate.

### Tissue Permeabilization and Treatment

In some embodiments, a biological sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X100™ or Tween-20™), and enzymes (e.g., trypsin, proteases). In some embodiments, the biological sample can be incubated with a cellular permeabilizing agent to facilitate permeabilization of the sample. Additional methods for sample permeabilization are described, for example, in Jamur et al., Method Mol. Biol. 588: 63-66, 2010, the entire contents of which are incorporated herein by reference. Any suitable method for sample permeabilization can generally be used in connection with the samples described herein.

In some embodiments, the biological sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the biological sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some embodiments, the biological sample can be permeabilized by non-chemical permeabilization methods. Non-chemical permeabilization methods are known in the art. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a biological sample to perform various functions prior to analysis of the sample. In some embodiments, Dnase and Rnase inactivating agents or inhibitors such as proteinase K, and/or chelating agents such as EDTA, can be added to the sample. For example, a method disclosed herein may include a step for increasing accessibility of a nucleic acid for binding, e.g., a denaturation step to opening up DNA in a cell for hybridization by a probe. For example, proteinase K treatment may be used to free up DNA with proteins bound thereto.

### Analytes

The methods and compositions disclosed herein can be used to detect and analyze a wide variety of different analytes. In some aspects, an analyte can include any biological substance, structure, moiety, or component to be analyzed. In some aspects, a target disclosed herein may similarly include any analyte of interest. In some examples, a target or analyte can be directly or indirectly detected.

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for analyte detection) to the analytes in the cell or cell compartment or organelle.

The analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed. Such a specific binding partner may be a nucleic acid probe (for a nucleic acid analyte) and may lead directly to the generation of a product. Alternatively, the specific binding partner may be coupled to a nucleic acid, which may be detected.

Analytes of particular interest may include nucleic acid molecules, such as DNA (e.g., genomic DNA, mitochondrial DNA, plastid DNA, viral DNA, etc.) and RNA (e.g., mRNA, microRNA, rRNA, snRNA, viral RNA, etc.), and synthetic and/or modified nucleic acid molecules, (e.g., including nucleic acid domains including or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof, or a lipid or carbohydrate molecule, or any molecule which include a lipid or carbohydrate component. The analyte may be a single molecule or a complex that contains two or more molecular subunits, e.g., including but not limited to protein-DNA complexes, which may or may not be covalently bound to one another, and which may be the same or different. Thus, in addition to cells or microorganisms, such a complex analyte may also be a protein complex or protein interaction. Such a complex or interaction may thus be a homo- or hetero-multimer. Aggregates of molecules, e.g., proteins may also be target analytes, for example aggregates of the same protein or different proteins. The analyte may also be a complex between proteins or peptides and nucleic acid molecules such as DNA or RNA, e.g., interactions between proteins and nucleic acids, e.g., regulatory factors, such as transcription factors, and DNA or RNA.

### Endogenous Analytes

In some embodiments, an analyte herein is endogenous to a biological sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that includes a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR.

In some embodiments described herein, an analyte may be a denatured nucleic acid, wherein the resulting denatured nucleic acid is single-stranded. The nucleic acid may be denatured, for example, optionally using formamide, heat, or both formamide and heat. In some embodiments, the nucleic acid is not denatured for use in a method disclosed herein.

In certain embodiments, an analyte can be extracted from a live cell. Processing conditions can be adjusted to ensure that a biological sample remains live during analysis, and analytes are extracted from (or released from) live cells of the sample. Live cell-derived analytes can be obtained only once from the sample or can be obtained at intervals from a sample that continues to remain in viable condition.

Methods and compositions disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any embodiment described herein, the analyte includes a target sequence. In some embodiments, the target sequence may be endogenous to the sample, generated in the sample, added to the sample, or associated with an analyte in the sample. In some embodiments, the target sequence is a single-stranded target sequence (e.g., a sequence in a rolling circle amplification product). In some embodiments, the analytes include one or more single-stranded target sequences. In one aspect, a first single-stranded target sequence is not identical to a second single-stranded target sequence. In another aspect, a first single-stranded target sequence is identical to one or more second single-stranded target sequence. In some embodiments, the one or more second single-stranded target sequence is included in the same analyte (e.g., nucleic acid) as the first single-stranded target sequence. Alternatively, the one or more second single-stranded target sequence is included in a different analyte (e.g., nucleic acid) from the first single-stranded target sequence.

### Labelling Agents

In some embodiments, provided herein are methods and compositions for analyzing endogenous analytes (e.g., RNA, ssDNA, and cell surface or intracellular proteins and/or metabolites) in a sample using one or more labelling agents. In some embodiments, an analyte labelling agent may include an agent that interacts with an analyte (e.g., an endogenous analyte in a sample). In some embodiments, the labelling agents can include a reporter oligonucleotide that is indicative of the analyte or portion thereof interacting with the labelling agent. For example, the reporter oligonucleotide may include a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some embodiments, the analyte labelling agent includes an analyte binding moiety and a labelling agent barcode domain including one or more barcode sequences, e.g., a barcode sequence that corresponds to the analyte binding moiety and/or the analyte. An analyte binding moiety barcode includes a barcode that is associated with or otherwise identifies the analyte binding moiety. In some embodiments, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some embodiments, the method includes one or more post-fixing (also referred to as post-fixation) steps after contacting the sample with one or more labelling agents.

In the methods and devices described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some embodiments, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may include a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some embodiments, an analyte binding moiety includes one or more antibodies or antigen binding fragments thereof. The antibodies or antigen binding fragments including the analyte binding moiety can specifically bind to a target analyte. In some embodiments, the analyte is a protein (e.g., a protein on a surface of the biological sample (e.g., a cell) or an intracellular protein). In some embodiments, a plurality of analyte labelling agents including a plurality of analyte binding moieties bind a plurality of analytes present in a biological sample. In some embodiments, the plurality of analytes includes a single species of analyte (e.g., a single species of polypeptide). In some embodiments in which the plurality of analytes includes a single species of analyte, the analyte binding moieties of the plurality of analyte labelling agents are the same. In some embodiments in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some embodiments, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may include nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected, e.g., using sequencing or array technologies.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31 (2): 708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide including a barcode sequence that identifies the label agent. For instance, the labelling agent may be directly coupled (e.g., covalently bound) to a hybridization oligonucleotide that includes a sequence that hybridizes with a sequence of the reporter oligonucleotide. Hybridization of the hybridization oligonucleotide to the reporter oligonucleotide couples the labelling agent to the reporter oligonucleotide. In some embodiments, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer binding sequence (such as an R1, R2, or partial R1 or R2 sequence).

In some cases, the labelling agent can include a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some embodiments, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent including an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

Products of Endogenous Analyte and/or Labelling Agent

In some embodiments, provided herein are methods and compositions for analyzing one or more products of an endogenous analyte and/or a labelling agent in a biological sample. In some embodiments, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product thereof is analyzed. In some aspects, the generation and/or processing of the analytes may be performed in the device and/or the analysis of the analytes may be performed in the device, such as by delivering reagents to a sample via a fluid source. For example, the generation, processing, and analysis may include but is not limited to reactions including hybridizations, ligations, binding, extension, amplifications, or other enzymatic reactions. In some embodiments, a labelling agent that directly or indirectly binds to an analyte in the biological sample is analyzed. In some embodiments, a product (e.g., a hybridization product, a ligation product, an extension product (e.g., by a DNA or RNA polymerase), a replication product, a transcription/reverse transcription product, and/or an amplification product of a labelling agent that directly or indirectly binds to an analyte in the biological sample is analyzed. In some embodiments, the reactions for generating any of the products (e.g., ligation, amplification, extension, hybridization) provided herein are performed in the devices provided herein.

### Hybridization

In some embodiments, a product of an endogenous analyte and/or a labelling agent is a hybridization product including the pairing of substantially complementary or complementary nucleic acid sequences within two different molecules, one of which is the endogenous analyte or the labelling agent (e.g., reporter oligonucleotide attached thereto). The other molecule can be another endogenous molecule or another labelling agent such as a probe. Pairing can be achieved by any process in which a nucleic acid sequence joins with a substantially or fully complementary sequence through base pairing to form a hybridization complex. For purposes of hybridization, two nucleic acid sequences are “substantially complementary” if at least 60% (e.g., at least 70%, at least 80%, or at least 90%) of their individual bases are complementary to one another.

Various probes and probe sets can be hybridized to an endogenous analyte and/or a labelling agent and each probe may include one or more barcode sequences. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set, and RNA-templated ligation probes. The specific probe or probe set design can vary.

### Ligation

In some embodiments, a product of an endogenous analyte and/or a labelling agent is a ligation product. In some embodiments, the ligation product is formed between two or more endogenous analytes. In some embodiments, the ligation product is formed between an endogenous analyte and a labelling agent. In some embodiments, the ligation product is formed between two or more labelling agent. In some embodiments, the ligation product is an intramolecular ligation of an endogenous analyte. In some embodiments, the ligation product is an intramolecular ligation of a labelling agent, for example, the circularization of a circularizable probe or probe set upon hybridization to a target sequence. The target sequence can be included in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some embodiments, the ligation involves chemical ligation. In some embodiments, the ligation involves template dependent ligation. In some embodiments, the ligation involves template independent ligation. In some embodiments, the ligation involves enzymatic ligation.

In some embodiments, the enzymatic ligation involves use of a ligase. In some aspects, the ligase used herein includes an enzyme that is commonly used to join polynucleotides together or to join the ends of a single polynucleotide. An RNA ligase, a DNA ligase, or another variety of ligase can be used to ligate two nucleotide sequences together. Ligases include ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases include bacterial ligases such as E. coli DNA ligase, Tth DNA ligase, Thermococcus sp. (strain 9° N) DNA ligase (9° N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some embodiments, the ligase is a T4 RNA ligase. In some embodiments, the ligase is a splintR ligase. In some embodiments, the ligase is a single stranded DNA ligase. In some embodiments, the ligase is a T4 DNA ligase. In some embodiments, the ligase is a ligase that has an DNA-splinted DNA ligase activity. In some embodiments, the ligase is a ligase that has an RNA-splinted DNA ligase activity.

In some embodiments, the ligation herein is a direct ligation. In some embodiments, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps”. In some embodiments, said ends are not ligated directly to each other, but instead occurs either via the intermediacy of one or more intervening (so-called “gap” or “gap-filling” (oligo) nucleotides) or by the extension of the 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo) nucleotide(s) which are complementary to a splint, padlock probe, or target nucleic acid.

The gap may be a gap of 1 to 60 nucleotides or a gap of 1 to 40 nucleotides or a gap of 3 to 40 nucleotides. In specific embodiments, the gap may be a gap of about 1, 2, 3, 4, 5, 6, 7, 8, 9, or 10 or more nucleotides, of any integer (or range of integers) of nucleotides in between the indicated values. In some embodiments, the gap between said terminal regions may be filled by a gap oligonucleotide or by extending 3′ end of a polynucleotide. In some cases, ligation involves ligating the ends of the probe to at least one gap (oligo) nucleotide, such that the gap (oligo) nucleotide becomes incorporated into the resulting polynucleotide. In some embodiments, the ligation herein is preceded by gap filling. In other embodiments, the ligation herein does not require gap filling.

In some embodiments, ligation of the polynucleotides produces polynucleotides with melting temperature higher than that of unligated polynucleotides. Thus, in some aspects, ligation stabilizes the hybridization complex containing the ligated polynucleotides prior to subsequent steps, including amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tm) of the DNA strands. This selectively reduces the concentration of annealed mismatched substrates (expected to have a slightly lower Tm around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some embodiments, the ligation herein is a proximity ligation of ligating two (or more) nucleic acid sequences that are in proximity with each other, e.g., through enzymatic means (e.g., a ligase). In some embodiments, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

### Primer Extension and Amplification

In some embodiments, a product is a primer extension product of an analyte, a labelling agent, a probe or probe set bound to the analyte (e.g., a circularizable probe bound to genomic DNA, mRNA, or cDNA), or a probe or probe set bound to the labelling agent (e.g., a circularizable probe bound to one or more reporter oligonucleotides from the same or different labelling agents).

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some embodiments, a product of an endogenous analyte and/or a labelling agent is an amplification product of one or more polynucleotides, for instance, a circular probe or circularizable probe or probe set. In some embodiments, the amplifying is achieved by performing rolling circle amplification (RCA). In other embodiments, a primer that hybridizes to the circular probe or circularized probe is added and used as such for amplification. In some embodiments, the RCA includes a linear RCA, a branched RCA, a dendritic RCA, or any combination thereof.

In some embodiments, the amplification is performed at a temperature between or between about 20° C. and about 60° C. In some embodiments, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some embodiments, upon addition of a DNA polymerase in the presence of appropriate dNTP precursors and other cofactors, a primer is elongated to produce multiple copies of the circular template. This amplification step can utilize isothermal amplification or non-isothermal amplification.

### Target Sequences

A target sequence for a probe disclosed herein may be included in any analyte disclose herein, including an endogenous analyte (e.g., a viral or cellular nucleic acid), a labelling agent, or a product of an endogenous analyte and/or a labelling agent.

In some aspects, one or more of the target sequences includes one or more barcode(s), e.g., at least two, three, four, five, six, seven, eight, nine, ten, or more barcodes. Barcodes can spatially-resolve molecular components found in biological samples, for example, within a cell or a tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode includes about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some embodiments, a barcode includes two or more sub-barcodes that together function as a single barcode. For example, a polynucleotide barcode can include two or more polynucleotide sequences (e.g., sub-barcodes) that are separated by one or more non-barcode sequences. In some embodiments, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In some embodiments, in a barcode sequencing method, barcode sequences are detected for identification of other molecules including nucleic acid molecules (DNA or RNA) longer than the barcode sequences themselves, as opposed to direct sequencing of the longer nucleic acid molecules. In some embodiments, a N-mer barcode sequence includes 4N complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (45=1024), whereas 8 nucleotide barcodes can be used to identify up to 65,536 molecular species, a number greater than the total number of distinct genes in the human genome. In some embodiments, the barcode sequences contained in the probes or RCPs are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 20190055594 and WO2019199579A1, which are hereby incorporated by reference in their entirety.

### Assays

The methods described herein may be useful for analysis methods in which specific reagents are added to a sample. In some embodiments, reagents are added to the sample in the device which include but are not limited to oligonucleotides (e.g., probes, dNTPs, primers), enzymes (e.g., endonucleases to fragment DNA, DNA polymerase enzymes, RNA polymerase, transposase, ligase, proteinase K, reverse transcriptase enzymes, including enzymes with terminal transferase activity, and DNAse), buffers and washes. In some embodiments, optical labels or dyes are added to the sample. In some embodiments, a sample can be collected from the device after performing steps of the assay described herein. In some embodiments, the device is used to perform or prepare sample for in situ analysis methods which include, e.g., in situ hybridization and in situ sequencing. In situ hybridization is a hybridization process in which labeled nucleic acids that are complementary to a specific nucleic acid (e.g., DNA or RNA) sequence in a biological sample hybridize to a portion or section of the sample (e.g., tissue) in which the nucleic acid is present. The methods described herein may be useful for array-based methods in which specific reagents are contacted with a sample. In some embodiments, the surface of the fluidic interface layer or substrate layer may have an array of bound reagents. In some embodiments, a device is used to deliver reagents to the sample which is deposited on the array.

The labeled nucleic acids, also referred to as probes, are generally short oligonucleotides in which at least a portion of the oligonucleotide is a reverse complement to a target nucleic acid of interest. The probes may include additional components in addition to the hybridization portion. For example, the probes may include additional sequences (e.g., barcode sequences), that are unique labels or identifiers to convey information about the nucleic acid being detected. The probes may further include a label attached thereto, directly or indirectly. The label may be, e.g., an optical label, a molecular label (e.g., an antigen), a radiolabel, or a field attractable label (e.g., electric or magnetic). In some embodiments the optical label is a fluorescent label, e.g., as used in fluorescence in situ hybridization (FISH). A fluorescent label can be detected by routine optical detection methods known in the art.

Optical detection may be performed by any detector capable of measuring light (e.g., the emitted, scattered, or attenuated light) from the label. Suitable detectors include, but are not limited to, a spectrometer, a light meter, a photometer, a photodiode, a photomultiplier tube, a CCD array, a CMOS sensor, or a photovoltaic device.

In situ methods may first include fixing and/or permeabilizing a biological sample (e.g., tissue). The biological sample may be provided in the device, e.g., on a substrate layer. The sample may be permeabilized by adding a fluid, such as a solvent (e.g., acetone and methanol) or a detergent (e.g., TRITON X-100, NP-40, TWEEN 20, saponin, digitonin, and Leucoperm), to the sample. Permeabilization may allow or enhance access of the probes for the intracellular space of the sample.

In some embodiments, a plurality of probes is used, e.g., for ease of detection and/or signal amplification, such as any probes described herein. For example, a first probe may include a nucleic acid sequence that hybridizes to a target nucleic acid in the sample. A secondary probe that includes a label (e.g., optical label, e.g., fluorescent label) may then be added that hybridizes to the first probe. In some embodiments, a plurality of secondary or higher order (e.g., tertiary, quaternary) detection probes are added. Each probe may be provided by a separate fluid source. Each probe may be provided by a single fluid source that includes a plurality of distinct probes.

When a probe that includes a detection label is added, the unbound probes with detection labels can be washed away and the signal can be detected, e.g., via fluorescence microscopy.

In some embodiments, the signal or template target nucleic acid is amplified. In some embodiments, an analyte (e.g., target nucleic acid) can be amplified using an enzyme, e.g., by polymerase chain reaction (PCR) or rolling circle amplification (RCA). The target nucleic acid may be replicated, e.g., by using the probe as a primer to initiate DNA or RNA synthesis. In such an embodiment, one or more fluids are added (e.g., sequentially) to the sample to provide the reagents for nucleic acid synthesis. Suitable reagents include, but are not limited to, probes, primers, nucleotide triphosphates (NTPs, e.g., dNTPs), sequencing terminators, dyes, polymerases, ligases, transcriptases (e.g., reverse transcriptases), labels, and the like.

In some embodiments, the methods described herein includes in situ sequencing or sequence detection. One such process includes temporal multiplexing of barcoded probes. In some embodiments, a primary probe or set of primary probes (e.g., 24 primary probes) hybridize to a target nucleic acid (e.g., mRNA) in the sample. Each probe may contain a barcode attached thereto. The barcodes may then be detected by contacting with one or more probes each labeled with a fluorescent label which emits a signal. Each round of barcoding may be initiated by flowing the desired probe from a new fluid source. The labels may be detected using different excitation wavelengths (e.g., 640 nm, 561 nm, or 488 nm) during different barcoding rounds. By compiling the spatiotemporal patterns of each fluorescent signal at a location, the unique set of ordered barcode sequences that corresponds to a particular gene can be determined. Such a method may allow multiplex sequencing of a large number of (e.g., of 100, 1,000, 10,000, or more) nucleic acids, e.g., up to 90,000 transcripts per cell. This method also allows for efficient quantification of low-copy number nucleic acids.

In some embodiments, the in situ detection and/or in situ sequencing is performed in three dimensions. In this embodiment, the biological sample may be sequence by using a probe that includes a unique gene identifier. The probe may be ligated, thereby allowing extension and amplification of the target sequence. In some embodiments, the amplification product can then be modified with a chemical moiety that polymerizes in the presence of a polymerization initiator. In some embodiments, an amplified product may be embedded within a polymerized matrix (e.g., a hydrogel), thereby creating spatially fixed three-dimensional target analytes of the biological sample.

In some embodiments, the in situ sequencing includes sequencing by ligation. In this embodiment, fluorescently labeled probes with two known bases followed by degenerate or universal bases hybridize to a temple. A ligase immobilizes the complex and the biological sample is imaged to detect the label on the probe. Following detection, the fluorophore is cleaved from the probe along with several bases, revealing a free 5′ phosphate. This process of hybridization, ligation, imaging, and cleavage can be repeating in multiple rounds, thereby allowing identification of, e.g., 2 out of every 5 bases. After a round of probe extension, all probes and anchors are removed and the cycle can begin again with an offset anchor, thus allowing sequencing of a new register of the target.

In another embodiment, sequencing by ligation includes labeled probes with a known base (e.g., A, C, T, or G) flanked on each side of the known base by degenerate or universal bases that hybridize to a template (e.g., three or four bases on each side). Each probe contains a different fluorescent label corresponding to each individual base. Each round of sequencing includes hybridizing a probe with a known base, ligation of the probe, detection, and optionally, cleavage of the fluorescent label. Sequencing can be performed in a plus or minus direction, and rounds of sequencing can begin again with an offset anchor, thus allowing sequencing of a new register of the target.

In some embodiments, detection of one or more analytes (e.g., protein analytes) can be performed using one or more analyte capture agents. In some embodiment, the devices described herein may include one or more analyte capture agents, e.g., an array of oligonucleotides. In some aspects, the array may include a bead array. As used herein, an “analyte capture agent” refers to an agent that interacts with an analyte (e.g., an analyte in a biological sample) and with a capture probe (e.g., a capture probe attached to a substrate or a feature) to identify the analyte. In some embodiments, the analyte capture agent includes: (i) an analyte binding moiety (e.g., that binds to an analyte), for example, an antibody or antigen-binding fragment thereof; (ii) analyte binding moiety barcode; and (iii) an analyte capture sequence. As used herein, the term “analyte binding moiety barcode” refers to a barcode that is associated with or otherwise identifies the analyte binding moiety. As used herein, the term “analyte capture sequence” refers to a region or moiety configured to hybridize to, bind to, couple to, or otherwise interact with a capture domain of a capture probe. In some cases, an analyte binding moiety barcode (or portion thereof) may be able to be removed (e.g., cleaved) from the analyte capture agent. Additional description of analyte capture agents can be found in Section (II) (b) (ix) of WO 2020/176788 and/or Section (II) (b) (viii) U.S. Patent Application Publication No. 2020/0277663.

There are at least two methods to associate a spatial barcode with one or more neighboring cells, such that the spatial barcode identifies the one or more cells, and/or contents of the one or more cells, as associated with a particular spatial location. One method is to promote analytes or analyte proxies (e.g., intermediate agents) out of a cell and towards a spatially-barcoded array (e.g., including spatially-barcoded capture probes). Another method is to cleave spatially-barcoded capture probes from an array and promote the spatially-barcoded capture probes towards and/or into or onto the biological sample.

In some cases, capture probes may be configured to prime, replicate, and consequently yield optionally barcoded extension products from a template (e.g., a DNA or RNA template, such as an analyte or an intermediate agent (e.g., a ligation product or an analyte capture agent), or a portion thereof), or derivatives thereof (see, e.g., Section (II) (b) (vii) of WO 2020/176788 and/or U.S. Patent Application Publication No. 2020/0277663 regarding extended capture probes). In some cases, capture probes may be configured to form ligation products with a template (e.g., a DNA or RNA template, such as an analyte or an intermediate agent, or portion thereof), thereby creating ligations products that serve as proxies for a template.

As used herein, an “extended capture probe” refers to a capture probe having additional nucleotides added to the terminus (e.g., 3′ or 5′ end) of the capture probe thereby extending the overall length of the capture probe. For example, an “extended 3′ end” indicates additional nucleotides were added to the most 3′ nucleotide of the capture probe to extend the length of the capture probe, for example, by polymerization reactions used to extend nucleic acid molecules including templated polymerization catalyzed by a polymerase (e.g., a DNA polymerase or a reverse transcriptase). In some embodiments, extending the capture probe includes adding to a 3′ end of a capture probe a nucleic acid sequence that is complementary to a nucleic acid sequence of an analyte or intermediate agent specifically bound to the capture domain of the capture probe. In some embodiments, the capture probe is extended using reverse transcription. In some embodiments, the capture probe is extended using one or more DNA polymerases. The extended capture probes include the sequence of the capture probe and the sequence of the spatial barcode of the capture probe.

In some embodiments, extended capture probes are amplified (e.g., in bulk solution or on the array) to yield quantities that are sufficient for downstream analysis, e.g., via DNA sequencing. In some embodiments, extended capture probes (e.g., DNA molecules) act as templates for an amplification reaction (e.g., a polymerase chain reaction).

Additional variants of spatial analysis methods, including in some embodiments, an imaging step, are described in Section (II) (a) of WO 2020/176788 and/or U.S. Patent Application Publication No. 2020/0277663. Analysis of captured analytes (and/or intermediate agents or portions thereof), for example, including sample removal, extension of capture probes, sequencing (e.g., of a cleaved extended capture probe and/or a cDNA molecule complementary to an extended capture probe), sequencing on the array (e.g., using, for example, in situ hybridization or in situ ligation approaches), temporal analysis, and/or proximity capture, is described in Section (II) (g) of WO 2020/176788 and/or U.S. Patent Application Publication No. 2020/0277663. Some quality control measures are described in Section (II) (h) of WO 2020/176788 and/or U.S. Patent Application Publication No. 2020/0277663.

Spatial information can provide information of biological and/or medical importance. For example, the methods and compositions described herein can allow for: identification of one or more biomarkers (e.g., diagnostic, prognostic, and/or for determination of efficacy of a treatment) of a disease or disorder; identification of a candidate drug target for treatment of a disease or disorder; identification (e.g., diagnosis) of a subject as having a disease or disorder; identification of stage and/or prognosis of a disease or disorder in a subject; identification of a subject as having an increased likelihood of developing a disease or disorder; monitoring of progression of a disease or disorder in a subject; determination of efficacy of a treatment of a disease or disorder in a subject; identification of a patient subpopulation for which a treatment is effective for a disease or disorder; modification of a treatment of a subject with a disease or disorder; selection of a subject for participation in a clinical trial; and/or selection of a treatment for a subject with a disease or disorder.

Spatial information can provide information of biological importance. For example, the methods and compositions described herein can allow for: identification of transcriptome and/or proteome expression profiles (e.g., in healthy and/or diseased tissue); identification of multiple analyte types in close proximity (e.g., nearest neighbor analysis); determination of up- and/or down-regulated genes and/or proteins in diseased tissue; characterization of tumor microenvironments; characterization of tumor immune responses; characterization of cells types and their co-localization in tissue; and identification of genetic variants within tissues (e.g., based on gene and/or protein expression profiles associated with specific disease or disorder biomarkers).

Typically, for spatial array-based methods, a substrate layer (e.g., as described herein) functions as a support for direct or indirect attachment of capture probes to features of the array. A “feature” is an entity that acts as a support or repository for various molecular entities used in spatial analysis. In some embodiments, some or all of the features in an array are functionalized for analyte capture. Exemplary substrates are described in Section (II) (c) of WO 2020/176788 and/or U.S. Patent Application Publication No. 2020/0277663. Exemplary features and geometric attributes of an array can be found in Sections (II) (d) (i), (II) (d) (iii), and (II) (d) (iv) of WO 2020/176788 and/or U.S. Patent Application Publication No. 2020/0277663.

Generally, analytes and/or intermediate agents (or portions thereof) can be captured when contacting a biological sample with a substrate including capture probes (e.g., a substrate with capture probes embedded, spotted, printed, fabricated on the substrate, or a substrate with features (e.g., beads, wells) including capture probes). As used herein, “contact,” “contacted,” and/or “contacting,” a biological sample with a substrate refers to any contact (e.g., direct or indirect) such that capture probes can interact (e.g., bind covalently or non-covalently (e.g., hybridize)) with analytes from the biological sample. Capture can be achieved actively (e.g., using electrophoresis) or passively (e.g., using diffusion). Analyte capture is further described in Section (II) (e) of WO 2020/176788 and/or U.S. Patent Application Publication No. 2020/0277663.

In some cases, spatial analysis can be performed by attaching and/or introducing a molecule (e.g., a peptide, a lipid, or a nucleic acid molecule) having a barcode (e.g., a spatial barcode) to a biological sample (e.g., to a cell in a biological sample). In some embodiments, a plurality of molecules (e.g., a plurality of nucleic acid molecules) having a plurality of barcodes (e.g., a plurality of spatial barcodes) are introduced to a biological sample (e.g., to a plurality of cells in a biological sample) for use in spatial analysis. In some embodiments, after attaching and/or introducing a molecule having a barcode to a biological sample, the biological sample can be physically separated (e.g., dissociated) into single cells or cell groups for analysis. Some such methods of spatial analysis are described in Section (III) of WO 2020/176788 and/or U.S. Patent Application Publication No. 2020/0277663.

In some embodiments, the macromolecular components (e.g., analytes) of individual biological samples (e.g., cells) can be identified or detected with unique identifiers (e.g., barcodes) such that upon characterization of those macromolecular components, such that any given component (e.g., bioanalyte) may be traced to the biological sample (e.g., cell) from which it was obtained. The ability to attribute characteristics to individual biological samples or groups of biological samples is provided by the assignment of unique identifiers specifically to an individual biological sample or groups of biological samples. Unique identifiers, for example, in the form of nucleic acid barcodes, can be assigned or associated with individual biological samples (e.g., cells) or populations of biological samples (e.g., cells), or genes (e.g., mRNA transcripts, in order to tag or label the biological sample's macromolecular components (and as a result, its characteristics) with the unique identifiers. These unique identifiers can then be used to attribute the biological sample's components and characteristics to an individual biological sample or group of biological samples.

In some aspects, the unique identifiers are provided in the form of oligonucleotides that include nucleic acid barcode sequences that may be attached to or otherwise associated with the nucleic acid contents of individual biological sample, or to other components of the biological sample, and particularly to fragments of those nucleic acids.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Moieties (e.g., oligonucleotides) used in the methods described herein can also include other functional sequences useful in processing of nucleic acids from biological samples contained in the droplet. These sequences include, for example, targeted or random/universal amplification primer sequences for amplifying the genomic DNA from the individual biological samples within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

The methods described herein may include providing molecular labels, e.g., via a fluid source. The molecular labels may include barcodes (e.g., nucleic acid barcodes). The molecular labels can be provided to the biological sample based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with cells or particulate components of interest. The lipophilic moiety may insert into the plasma membrane of a cell thereby labeling the cell with the barcode. The devices and methods of the present disclosure may result in molecular labels being present on (i) the interior of a cell or particulate component and/or (ii) the exterior of a cell or particulate component (e.g., on or within the cell membrane). These and other suitable methods will be appreciated by those skilled in the art (see U.S. Pub. Nos. US20190177800, US20190323088, US20190338353, and US20200002763, each of which is incorporated herein by reference in its entirety).

In an example, a fluid is provided that includes large numbers of the above-described barcoded oligonucleotides releasably attached to a label. In some cases, a fluid will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more.

Oligonucleotides may be releasable from the labels (e.g., optical label, e.g., fluorescent label) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature will result in cleavage of a linkage or other release of the oligonucleotides from the label. In still other cases, a chemical stimulus is used that cleaves a linkage of the oligonucleotides to the label, or otherwise results in release of the oligonucleotides from the label, e.g., beads.

### Methods of Device Manufacture

The devices of the present disclosure may be fabricated in any of a variety of conventional ways. These structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

A gasket of the present disclosure may be made in whole or in part from, e.g., a polymer, e.g., a silicone (e.g., silicone rubbers, e.g., PDMS), fluorosilicone, FKM, FFKM, COC elastomer, etc. The gasket may include an elastomeric polymer, e.g., be cut or formed from an elastomeric material, or precursors thereof, e.g., to allow the gasket to be compressible. A gasket may be a composite of compressible and incompressible materials, e.g., an elastomeric polymer bonded to a non-elastomeric polymer, e.g., formed by bonding (e.g., thermally or with adhesive) two or more materials together. Gaskets may include thermoset or thermoplastic polymers, or a combination thereof. A gasket may be coated, e.g., to include a one-sided adhesive, a double-sided adhesive, a polymer coating, or a hydrophobic coating. A hydrophobic coating on the gasket may act to improve sealing (e.g., to prevent leaks), and/or to reduce adhesion between the gasket and the fluidic interface layer and/or substrate layer, e.g., to allow for easier removal.

A gasket of the disclosure may be formed in place on the fluidic interface layer. For example, a gasket may be printed in place, e.g., using screen printing, CNC controlled nozzle deposition, 3D printing of elastomers on the surface, UV curable processes (e.g., stereolithography), etc. In some embodiments, a gasket may be formed on the fluidic interface by dispensing beads of curable elastomers, e.g., moisture or UV curable elastomers, or, e.g., two-part RTV elastomers. In some embodiments, a gasket may be produced by laser cutting of a continuous gasket layer already laminated on to the substrate layer or fluidic interface layer.

The fluidic interface layer and substrate layers may be made in whole or in part from glass, polymer (e.g., polystyrene, polycarbonate, polyethylene terephthalate, polypropylene, polyethylene, PTFE, COC, PMMA, etc.), plastic, ceramic, metal, or a combination thereof. The fluidic interface may be constructed of multiple layers, e.g., a top layer and a bottom layer.

Polymeric device components may be fabricated using any of a number of processes including soft lithography, embossing techniques, micromachining, e.g., laser machining, or, in some aspects, injection molding of the layer components that include the defined channels as well as other structures, e.g., reservoirs, integrated functional components, etc. In such cases, a laminating layer may be adhered to the molded structured part through readily available methods, including thermal lamination, solvent based lamination, sonic welding, or the like.

As will be appreciated, structures included of inorganic materials also may be fabricated using known techniques. For example, structures such as channels or reservoirs may be micro-machined into surfaces or etched into the surfaces using standard photolithographic techniques. In some aspects, the devices or components thereof may be fabricated using three-dimensional printing techniques to fabricate the channel or other structures of the devices and/or their discrete components.

### Methods for Surface Modifications

The disclosure features methods for producing a flow device (e.g., a microfluidic device) that has a surface modification, e.g., a surface with a modified water contact angle. The methods may be employed to modify the surface of a device such that a liquid can “wet” the surface by altering the contact angle the liquid makes with the surface.

Devices to be modified with surface coating agents may be primed, e.g., pre-treated, before coating processes occur. In certain embodiments, the first contact angle is greater than the water contact angle of the primed surface. In other embodiments, the first contact angle is greater than the water contact angle of the device component surface. Thus, the method allows for the differential coating of surfaces within or on the device.

A surface may be primed by depositing a metal oxide onto it. Example metal oxides useful for priming surfaces include, but are not limited to, Al2O3, TiO2, SiO2, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al2O3 can be prepared on a surface by depositing trimethylaluminum (TMA) and water.

In some cases, the coating agent may create a surface that has a water contact angle greater than 90°, e.g., hydrophobic or fluorophillic, or may create a surface with a water contact angle of less than 90°, e.g., hydrophilic. For example, a fluorophillic surface may be created by flowing fluorosilane (e.g., H3FSi) through a primed device surface, e.g., a surface coated in a metal oxide. The priming of the surfaces of the device enhances the adhesion of the coating agents to the surface by providing appropriate surface functional groups. In some cases, the coating agent used to coat the primed surface may be a liquid reagent.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. An adapter for an open well flow cell, the adapter comprising:
a body having:
an upper surface;
a lower surface spaced from the upper surface defining a thickness profile therebetween;
at least one side extending about a perimeter of the body;
an inlet formed in the body extending through the thickness of the upper surface and the lower surface;
at least one foot extending from the lower surface, each foot of the at least one foot extending a vertical distance away from the lower surface; and
a protrusion extending from the upper surface.

2. The adapter of claim 1, wherein the thickness profile is about 100 μm to about 5 mm.

3. The adapter of claim 1, wherein the vertical distance of each foot of the at least one foot is about 10 μm to about 500 μm.

4. (canceled)

5. (canceled)

6. The adapter of claim 1, wherein the body comprises a rectangular shape with a plurality of corners comprising at least one arcuate corner.

7. The adapter of claim 1, wherein the inlet comprises a notch formed in the at least one side, wherein the notch extends from the upper surface to the lower surface.

8. The adapter of claim 7, wherein the notch is formed at a corner of the plurality of corners.

9. The adapter of claim 7, wherein the notch comprises an arcuate cutout.

10. The adapter of claim 1, wherein the inlet comprises a through hole disposed at a location spaced from the at least one side of the body.

11. (canceled)

12. The adapter of claim 1, wherein the lower surface is planar.

13. (canceled)

14. The adapter of claim 1, wherein the top surface is planar.

15. (canceled)

16. (canceled)

17. The adapter of claim 1, wherein the adapter further comprises a lip extending from the upper surface and around the perimeter of the body.

18. The adapter of claim 17, where the inlet extends through the lip.

19. (canceled)

20. (canceled)

21. The adapter of claim 1, wherein the protrusion extends a vertical distance away from the upper surface of the body, wherein the vertical distance is about 1 mm to about 20 mm.

22. (canceled)

23. (canceled)

24. The adapter of claim 1, wherein the at least one side includes the plurality of feet.

25. (canceled)

26. (canceled)

27. (canceled)

28. (canceled)

29. (canceled)

30. (canceled)

31. (canceled)

32. (canceled)

33. (canceled)

34. (canceled)

35. A reversible flow cell assembly, the assembly comprising:
a cassette formed by an upper casing and a lower casing, wherein the upper casing is releasably coupled to the lower casing, wherein a gap is formed between the upper casing and the lower casing when the upper casing is coupled to the lower casing,
a sample substrate disposed in the gap;
an opening formed in the upper casing, the opening circumscribed by a gasket, wherein the gasket and the sample substrate form an open well;
the adapter of claim 1 disposed in the well.

36. The assembly of claim 35, further comprising a cassette lid disposed over the well and the adapter, the cassette lid configured to couple to the upper casing of the cassette and form a seal with the gasket.

37. (canceled)

38. (canceled)

39. The assembly of claim 35, wherein the perimeter of the body is configured to substantially match a profile of the open well flow cell.

40.-69. (canceled)

70. A method comprising:
providing an open well flow cell assembly having a sample disposed on a substrate, the open well flow cell assembly comprising:
a cassette formed by an upper casing and a lower casing, wherein the upper casing is releasably coupled from the lower casing, wherein a gap is formed between the upper casing and the lower casing when the upper casing is coupled to the lower casing;
a sample substrate disposed in the gap;
an opening formed in the upper casing, the opening circumscribed by a gasket, wherein the gasket and the sample substrate form an open well;
positioning the adapter of claim 1 in the open well to thereby form a reversible flow cell;
flowing at least one reagent into the inlet thereby contacting the sample with the at least one reagent.

71. The method of claim 70, further comprising sealing the open well cassette with a lid.

72. The method of claim 70, further comprising thermocycling the reversible flow cell.
